(19) United States
(12) Patent Application Publication
(10) Pub. No.: US 2016/0140654 A1
(43) Pub. Date: May 19, 2016

(54) AUTOMATED PROCESS WORKFLOW FOR THE ENTIRE MORTGAGE LOAN AND CLOSING PROCESS

(71) Applicant: Blue Igloo, Inc., Burlingame, CA (US)

(72) Inventors: Rajesh Pervaje Bhat, Burlingame, CA (US); Harry Cheung, Atherton, CA (US); Jonathan Kirst, Oakland, CA (US)

(73) Assignee: Blue Igloo, Inc.

(21) Appl. No.: 14/540,703

(22) Filed: Nov. 13, 2014

(51) Int. Cl. G06Q 40/02; G06Q 10/06

(52) U.S. Cl. CPC G06Q 40/025; G06Q 10/06316

(57) ABSTRACT

A cloud-based mortgage software service to automate the residential mortgage application process by i) presenting a combination of fields, forms, and pages to solicit information from a borrower for a residential mortgage loan application and then comparing that extracted information to some information on trigger conditions for borrower documents needed for the loan. A database contains and indexes information regarding i) mortgage guidelines and requirements for residential mortgage loans. The mortgage software service automates the mortgage application process by reconciling i) the extracted information to ii) any trigger conditions in the database associated with the borrower documentation needed from the mortgage guidelines and the overlays to reinforce or verify the extracted information in the fields and forms by the borrower, and then generate a list of needed borrower documents that will be needed by the underwriter based on the guidelines of the government-sponsored lending institutions and the overlays required by direct lending corporations.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### BACKGROUND

Some embodiments relate to a provider of automated real estate transaction technology. Some on-line mortgage companies exist, such as Quicken Loans Inc.; however, each of these on-line mortgage companies merely deals with obtaining information from its own borrowers and formatting data for use in its own system.

### SUMMARY

Various methods and apparatus are discussed including a method for cloud-based mortgage software service hosted on a cloud-based provider site that automates a residential mortgage application process. The cloud-based mortgage software service is configured to be hosted on the cloud-based provider site that contains one or more servers and one or more databases. The cloud-based mortgage software service is configured to utilize a protocol, such as HTTP, to engage in a request and response cycle with both a mobile device application resident on a client device as well as a web-browser application resident on the client device. The cloud-based mortgage software service is configured to have one or more routines to automate the residential mortgage application process by i) presenting a combination of fields, forms, and pages to solicit information from a borrower using the client device for a residential mortgage loan application then applying logic to extract information put into the fields and forms by the borrower and comparing that extracted information to some information on trigger conditions for borrower documents stored in the one or more databases, and then ii) returning a list of documents that present one or more icons to activate an upload routine to upload a plurality of borrower's documents over a network from the client device into the one or more databases. A first database is configured to contain and index information regarding i) mortgage guidelines and requirements for residential mortgage loans, including any accompanying borrower's documentation needed from one or more government-sponsored lending institutions as well as ii) any additional information from one or more direct lending corporations. The additional information includes requirements from investor overlays and any additional documentation requirements needed to supply a complete loan application to an underwriter of that direct lending corporation, such as a bank or credit union, to approve the loan application. The cloud-based mortgage software service is configured to automate the mortgage application process by reconciling i) the extracted information to ii) any trigger conditions in the database associated with the borrower documentation needed from the mortgage guidelines and the overlays to reinforce or verify the extracted information in the fields and forms by the borrower, and then generate a list of needed borrower documents that will be needed by the underwriter based on the guidelines of the government-sponsored lending institutions and the overlays required by direct lending corporations. The cloud-based mortgage software service is configured to then present the list of borrower documents currently uploaded and borrower documents still needed on a display screen of the client device. The cloud-based mortgage software service can be implemented in software, hardware electronics, and any combination of both and when one or more portions of the system are implemented in software, then that software is tangibly stored in an executable format on the one or more non-transitory storage mediums.

### BRIEF DESCRIPTION OF THE DRAWINGS

The multiple drawings refer to the embodiments of the design.

FIG. 1 illustrates a block diagram of an example computing system that may use an embodiment of one or more of the software applications discussed herein.

FIGS. 2A and 2B illustrate block diagrams of an embodiment of a cloud-based mortgage software service hosted on a cloud-based provider site that automates a residential mortgage application process.

FIG. 3 illustrates a page of an embodiment of the cloud-based mortgage software service that has one or more routines to present a combination of fields, forms, and pages to solicit information from a borrower and extract information put into the fields and forms by the borrower.

FIG. 4 illustrates a page of an embodiment of the cloud-based mortgage software service that conveys a list of needed borrower documents needed throughout the loan and closing process.

FIGS. 5A and 5B illustrate pages of an embodiment of the cloud-based mortgage software service that conveys borrower documents that have been uploaded as well as additional documents that still need to be uploaded.

FIGS. 6A and 6B illustrate calendar pages of an embodiment of the cloud-based mortgage software service that conveys when tasks are due, appointments exist, etc.

FIGS. 7A and 7B illustrate pages of an embodiment of the cloud-based mortgage software service that allow a borrower to establish a link between the software service and one or more institutions that contain information or maintain an account for the borrower.

FIG. 8 illustrates a page of an embodiment of the mortgage software service that presents an application programming interface used to export information from the mortgage software service.

FIG. 9 illustrates a page of an embodiment of the mortgage software service that presents a graphic user interface to allow one or more direct lending institutions as well as other institutions to customize exports information from the software service into their institution.

FIG. 10 illustrates a page of an embodiment of the cloud-based mortgage software service coded to present the list of needed borrower documents and the borrower can activate the upload icon in order to upload the corresponding borrower's document securely to the provider site.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific routines, named components, connections, types of servers, etc., in order to provide a thorough understanding of the present design. It will be apparent, however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details may be varied from and still be contemplated to be within the spirit and scope of the present design.

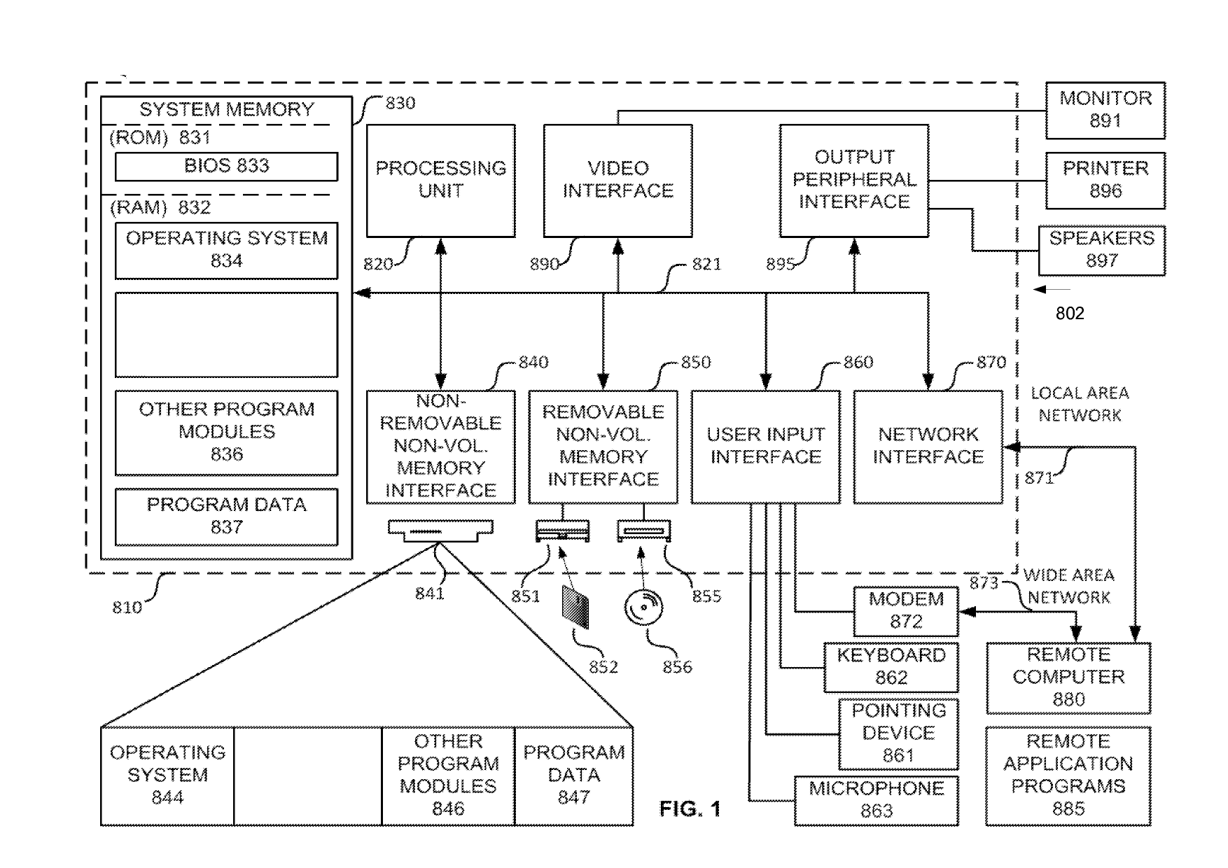

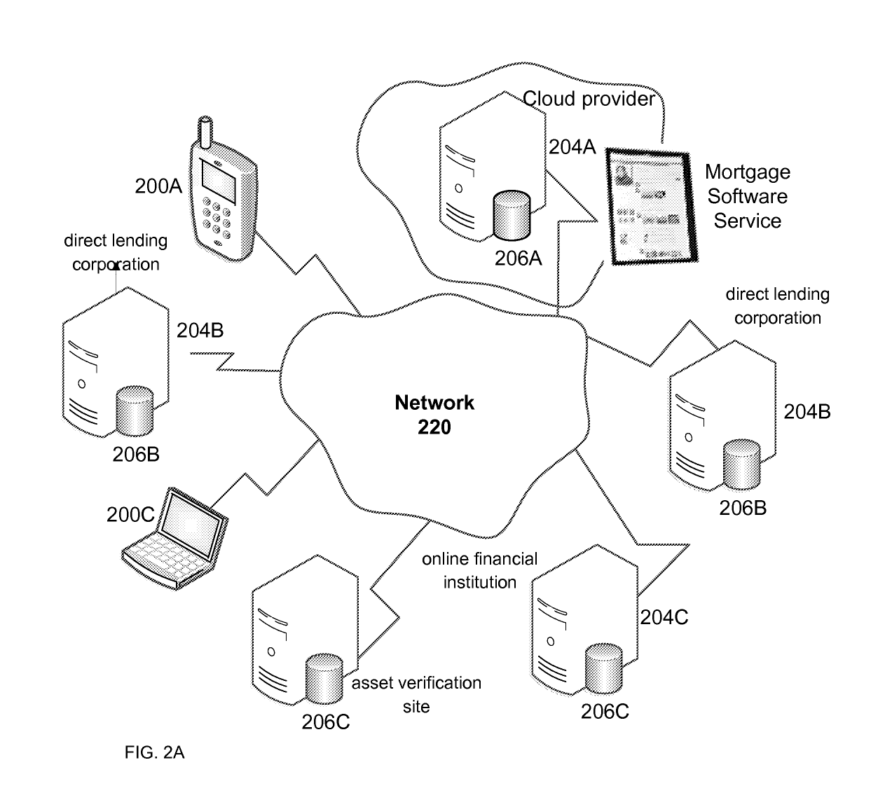

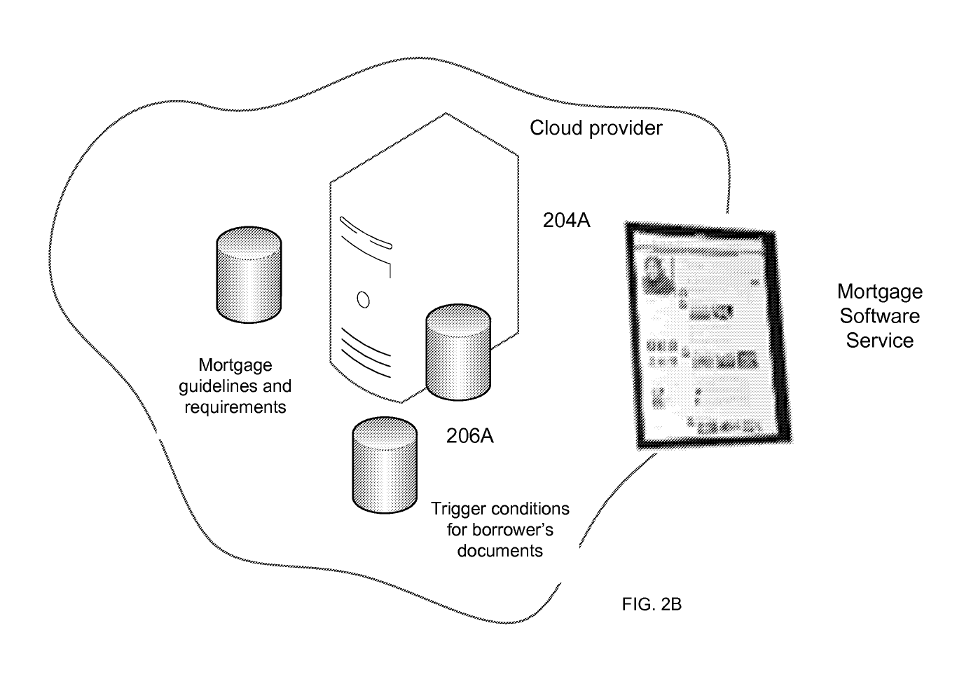

Example processes for and apparatuses to provide an automated process workflow for the entire mortgage loan and closing process are described. The following drawings and text describe various example implementations of the design. FIG. 1 and FIGS. 2A-2B illustrate example environments to implement the concepts. One or more scripted routines for the mortgage software service are configured to collect and provide features such as those described herein. The routines/algorithms in the mortgage software service are scripted to make many nexuses based on the collected information.

Various methods and apparatus are discussed including a method for cloud-based mortgage software service hosted on a cloud-based provider site that automates a residential mortgage application process. In general, the cloud-based mortgage software service automates the residential mortgage application process by i) presenting a combination of fields, forms, and pages to solicit information from a borrower for a residential mortgage loan application and then comparing that extracted information to some information on trigger conditions for borrower documents needed for the loan. A database contains and indexes information regarding i) mortgage guidelines and requirements for residential mortgage loans. The mortgage software service automates the mortgage application process by reconciling i) the extracted information to ii) any trigger conditions in the database associated with the borrower documentation needed from the mortgage guidelines and the overlays to reinforce or verify the extracted information in the fields and forms by the borrower, and then generate a list of needed borrower documents that will be needed by the underwriter based on the guidelines of the government-sponsored lending institutions and the overlays required by direct lending corporations.

FIGS. 2A and 2B illustrate block diagrams of an embodiment of a cloud-based mortgage software service hosted on a cloud-based provider site that automates a residential mortgage application process. The cloud-based mortgage software service is hosted on a cloud-based provider site that contains one or more servers and one or more databases. The cloud-based mortgage software service is coded to utilize a protocol, such as Hypertext Transfer Protocol (HTTP), to engage in a request and response cycle with both a mobile device application resident on a client device as well as a web-browser application resident on the client device, where the cloud-based mortgage software service has one or more routines to automate a residential mortgage application process. The cloud-based mortgage software service can be accessed by a mobile device, a desktop, a tablet device and other similar devices, anytime, anywhere. Thus, the cloud-based mortgage software service hosted on a cloud-based provider site is coded to engage in 1) the request and response cycle from all web browser based applications, 2) SMS/twitter based request and response message exchanges, 3) the request and response cycle from a dedicated on-line server, and 4) the request and response cycle directly between a native mobile application resident on a client device and the cloud-based mortgage software service.

Next, a first database in the one or more databases is configured to contain and index information regarding i) mortgage guidelines and requirements for residential mortgage loans, including any accompanying borrower's documentation needed, from one or more government-sponsored lending institutions, such as the Federal National Mortgage Association (FNMA) commonly known as Fannie Mae, or the Federal Home Loan Mortgage Corporation (FHLMC) commonly known as Freddie Mac, as well as ii) any additional information from one or more direct lending corporations, including banks, credit unions, mortgage brokers, and other thrifts. The additional information from the direct lending corporations includes requirements from investor overlays and any additional documentation requirements needed to supply a complete loan application to an underwriter of that direct lending corporation to approve the loan application. Note, a site for a direct lending institution can include a site for a bank, a site for a credit union, a site for a mortgage broker, and other similar sites.

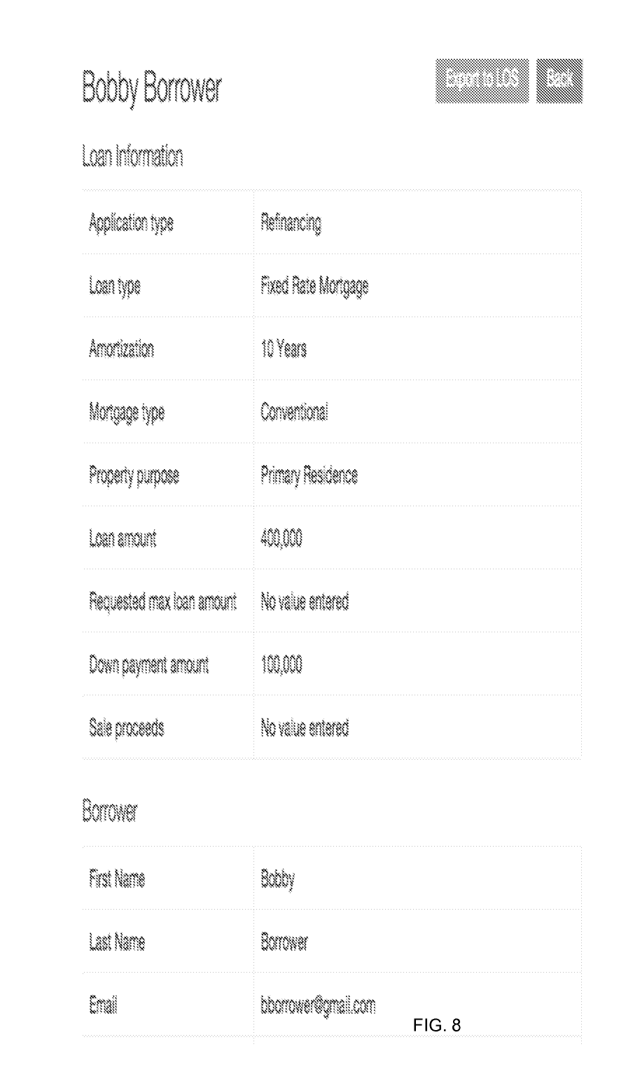

The first database contains and indexes i) documentation needed under every possible situation for a loan approval from the government-sponsored lending institutions underneath its mortgage guidelines as well as ii) all of the potential documentation needed based on the investor overlays from the two or more the direct lending institutions. An application programming interface (API) in the mortgage software service allows each direct lending institution to create multiple instances of investor overlays to be applied regarding that direct lending institution based on information including but not limited to i) a type of loan being requested, ii) an amount of the loan being requested, iii) an amount of assets or income of the borrower requesting the loan, iv) employment history, v) credit history, vi) asset history, vii) and any other borrower liabilities including alimony and child support, and vii) any combination of these factors. Also see, FIG. 8 for an example type of API presented to direct lending institution to create each set of requirements needed for a loan.

The cloud-based mortgage software service may be coded to extract information from borrowers. The extracted information from the solicited information is reconciled by an algorithm of the software service against the government-sponsored lending institutions guidelines and lending institution/investor overlays for the type of borrower's documentation needed, such as W-2s, employment information, identity information, current and previous residential information, credit information, etc.

A second database of the one or more databases indexes and contains one or more trigger conditions that trigger the need for the documentation needed by the mortgage guidelines of government-sponsored lending institutions and the overlays of the direct lending corporations. The information on trigger conditions for borrower documents is stored in the one or more databases.

Thus, the first database exists with the documentation needed, for example, under every possible situation for a Fannie Mae loan or Freddie Mac loan underneath their guidelines and the conditions that trigger the need for that documentation. Another discrete database can exist for all of the potential documentation needed based on the investor overlays and requirements and the conditions associated with the need for each one of the documents. The automated application of the mortgage software service solicits the information from the applicant/borrower and then reconciles solicited information versus trigger conditions that exist for the need for the documentations and then generates a list of documentation that will be needed.

The mortgage software service centralizes all documents in one location so that nothing falls through the cracks. The borrower can upload the documentation needed for the loan and closing process. The mortgage software service presents a list of documents with one or more icons to activate an upload routine, which then uploads the borrower's document over a network from the client device into the one or more databases. The loan application information and accompanying documentation of the borrower are stored in an encrypted form while stored in the one or more databases of the provider site.

The cloud-based mortgage software service has one or more application programming interfaces with two or more of the direct lending institutions. The cloud-based mortgage software service is coded to establish a secure communication link between each direct lending institutions and the provider site. The software service is coded to establish the secure communication link by creating a tunnel at the socket layer and encrypting any data while in transit between each direct lending institutions and the provider site as well as to satisfy any additional authentication mechanisms required by the direct lending institution, including but not limited to IP address white listing and token based authentication.

Note, information on a borrower may be received directly from an API from another on-line site, such as from a mortgage broker or another direct lending institution.

The cloud based mortgage software service is a middle support service interconnecting the on-line financial institutions, direct lender's loan origination systems, and asset verification sites. The cloud-based mortgage software service has one or more application programming interfaces and is coded to establish a secure communication link with two or more on-line financial institutions. The cloud-based mortgage software service has one or more application programming interfaces with two or more direct lender's loan origination systems and is coded to establish a secure communication link with the direct lender's loan origination systems. The cloud-based mortgage software service has one or more application programming interfaces with one or more asset verification sites with a secure communication link between the asset verification site and the provider site in order to allow a borrower's assets entered into the field and forms of the software service to be verified by the asset verification site. The asset verification site then provides the verification of the borrower's assets to the provider site. The mortgage software service is configured to receive the verification of the borrower's assets from the asset verification site, which then the software service exports the verification of the borrower's assets to the direct lender's loan origination system.

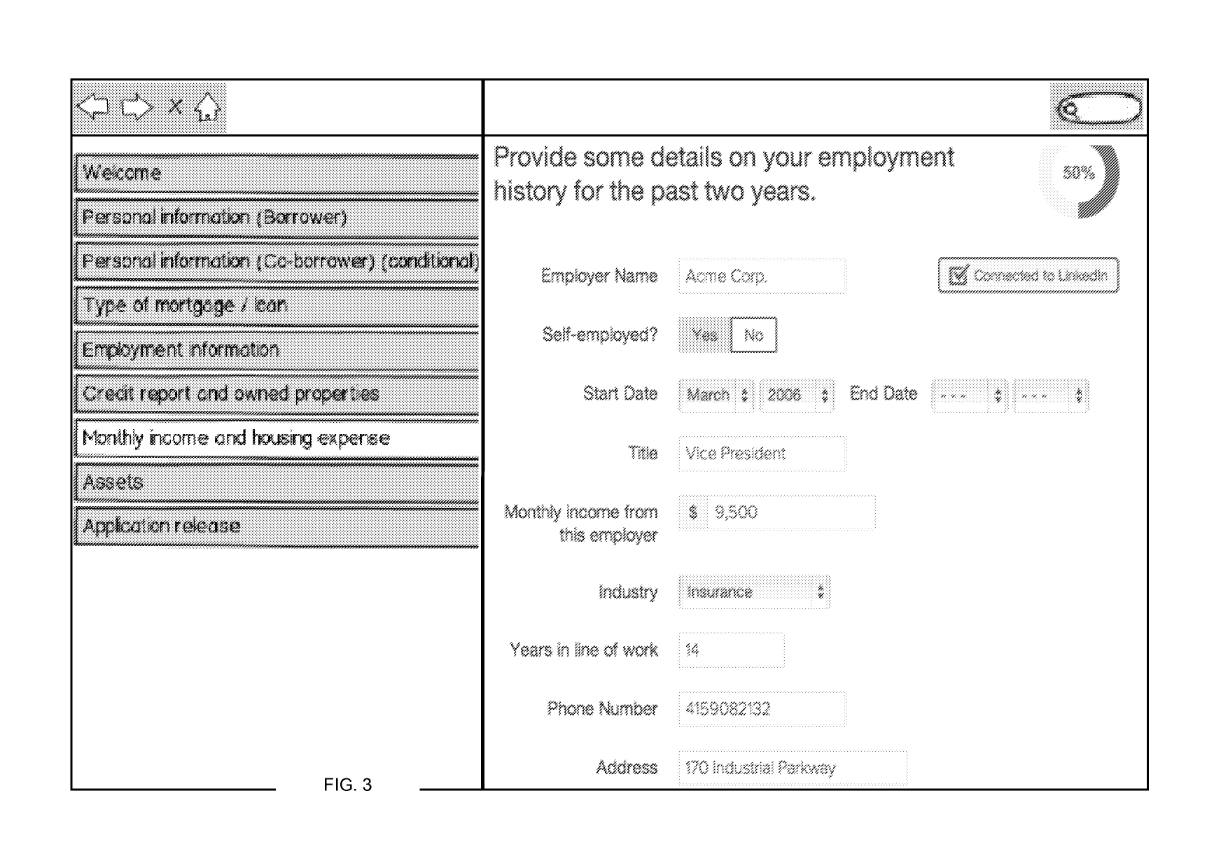

FIG. 3 illustrates a page of an embodiment of the cloud-based mortgage software service that has one or more routines to present a combination of fields, forms, and pages to solicit information from a borrower and extract information put into the fields and forms by the borrower. The cloud-based mortgage software service has one or more routines to automate a residential mortgage application process by i) presenting a combination of fields, forms, and pages to solicit information from a borrower using the client device for a residential mortgage loan application and then ii) applying logic to extract information put into the fields and forms by the borrower and iii) comparing that extracted information to some information on trigger conditions for borrower documents stored in the one or more databases. The cloud-based mortgage software service is coded to then ii) return a list of documents that present one or more icons to activate an upload routine to upload a plurality of borrower's documents over a network from the client device into the one or more databases. After an initial submission of a loan application, any subsequent modifications to the mortgage application will trigger the algorithm of the routines to repeat this process again.

The cloud-based mortgage software service is coded to present a series of page templates each with a different function. The pages include, but will not be limited to, a welcome page, a borrower's page, a co-borrower page, an employment page, an income page, an assets and liabilities page, a loan page, a declarations page, a people tab page to collect and list people involved in a loan process and closing process along with their contact information, and a loan application release form.

In an embodiment, the welcome page gives an overview of the process step-by-step of how to go through the forms and what to expect in this process. The borrower's page collects information about the Borrower's personal information such as name, birthday, address, other personal information. Likewise the co-borrower's page collects personal information on other people on the loan. The loan page collects details about the amount of the loan, length of the loan, type of loan, and other details regarding the loan. The employment page collects information about the current and past employment of the borrower or co-borrower, including employer name of the borrower or self-employed, start dates, job titles, industry, years in this line in the work, work phone number, address of the employer, etc. A hyperlink next to this information can be activated to obtain this employment information from a website such as LinkedIn or Facebook. The income page collects information about monthly income and yearly income that the borrower has. The assets and liabilities page solicits information about assets and liabilities that the borrower has to put up as collateral or other information regarding this loan. The declarations page collects declarations that the borrower needs to make. The application review page let you submit the loan application and review the documentation for the loan application that currently is in the application before you submit the loan application. The documents page/folder will generate a list of the documentation that would be needed for the loan prior to submitting loan as well as after submitting the loan and then again list documents later in the closing process.

The cloud-based mortgage software service is coded as cloud-based mortgage software service that helps lenders convert mortgage applications, close home loans, and create positive customer experiences. The cloud-based mortgage software service being coded to bilaterally communication via a web-browser, SMS based messages, and native mobile application service that makes the home buying experience easier and quicker for everyone involved.

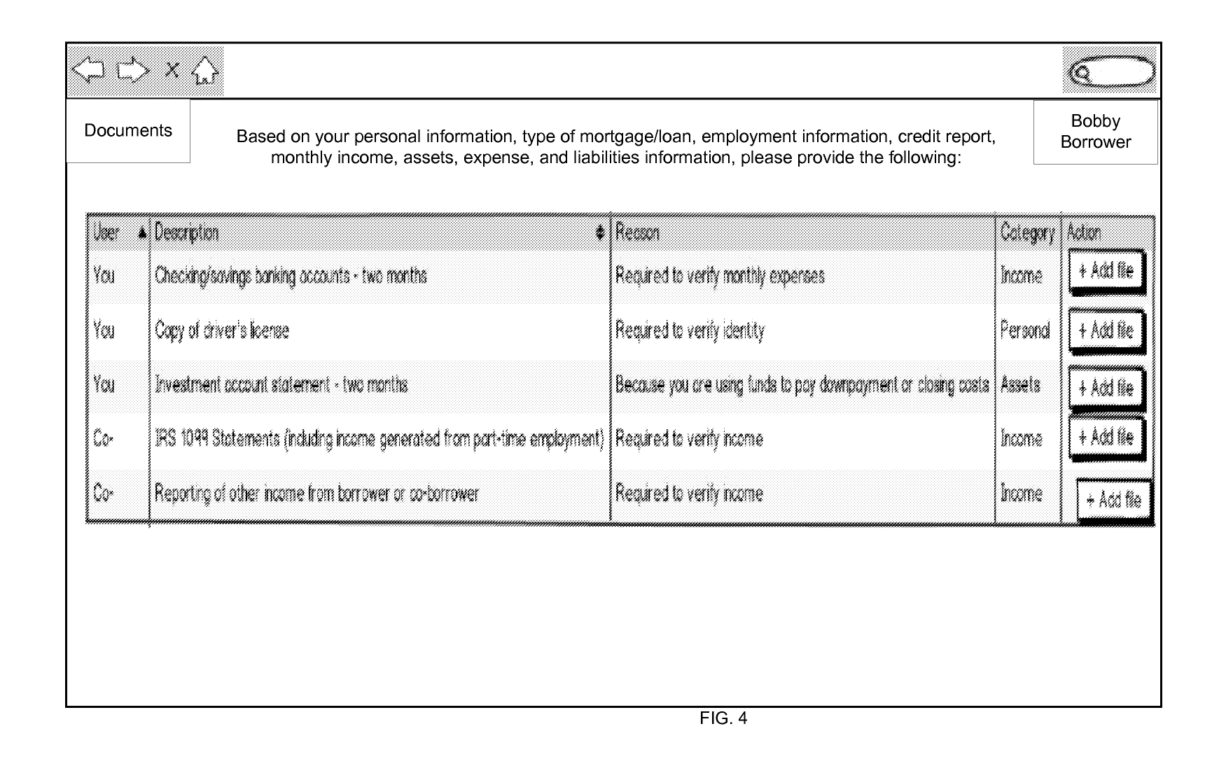

FIG. 4 illustrates a page of an embodiment of the cloud-based mortgage software service that conveys a list of needed borrower documents needed throughout the loan and closing process.

The cloud-based mortgage software service presents a list of needed borrower documents that will be needed by the underwriter based on the guidelines of the government-sponsored lending institutions and the overlays required by direct lending corporations on the display of a client device. For example, based on the borrower's personal information, type of mortgage/loan, employment information, credit report, monthly income, assets, expense, and liabilities information, the routines ask the borrower to provide example documents such as checking/savings banking accounts-two months; copy of driver's license; Investment account statement—two months; IRS Statements; etc. Having all of the needed documents submitted early in the process based on both the governmental lender guidelines and additional individual lender overlays allows qualifying and verifying the documentation early, which allows the mortgage loan to get approved faster and speeds up the closing process. Once you, the borrower, has provided as much documentation as you can, then the borrower should click the ‘release to my loan” button on this page. The borrower will be able to access this page/checklist afterwards and add any documentation that the borrower could not provide at this time.

The cloud-based mortgage software service generates a customized workflow process for each individual borrower/applicant utilizing these routines based on the information being solicited out of the fields of the cloud-based mortgage software service. The extracted information then causes the triggering of conditions associated with the borrower documentation needed for the underwriter as well as the software service to present any additional on-line forms to be filled out by the borrower based on the trigger conditions. After a routine of the software service reconciles the extracted information against the conditions that triggered the borrower documentation needed, then the cloud-based mortgage software service will generate and post a list of documentation that will be needed from this particular borrower for the loan based on their extracted information.

Some example documents are listed in the table below.

| Document Name | Belongs to | Multiple | Description | |
|---|---|---|---|---|
| AutoLoanStatement | Borrower, | Yes | Your most | |
| | Coborrower | | recent statement | |
| | | | concerning your | |
| | | | Auto Loan | |
| BusinessTaxReturn | Borrower, | Yes | Business tax | |
| | Coborrower | | returns for self- | |
| | | | employed | |
| | | | borrower or co- | |
| | | | borrower - two | |
| | | | years | |
| BuyerAgreement | Borrower, | No | Executed buyout | If |
| | Coborrower | | plan from an | employer |
| | | | employer | relocation |
| | | | relocation | and |
| | | | program | employer |
| | | | | bought |
| | | | | home |
| CheckingSavingsAccountStatement | Borrower, | Yes | Checking/savings | |
| | Coborrower | | banking | |
| | | | accounts | |
| | | | [Upload] - two | |
| | | | months | |
| DriversLicense | Borrower, | Yes | Copy of | |
| | Coborrower | | borrower and | |
| | | | co-borrower's | |
| | | | drivers license | |
| HOAStatement | Borrower, | Yes | Homeowner | |
| | Coborrower | | Association | |
| | | | statement for | |
| | | | currently owned | |
| | | | properties | |
| HomeEquityStatement | Borrower, | No | statement of | |
| | Coborrower | | outstanding | |
| | | | home equity | |
| | | | loan - balance, | |
| | | | payment, etc | |
| HomeOwnersInsuranceStatement | Borrower, | Yes | Homeowner | |
| | Coborrower | | insurance | |
| | | | statements for | |
| | | | currently owned | |
| | | | properties | |
| InvestmentAccountStatement | Borrower, | Yes | Two months | |
| | Coborrower | | | |
| IRSForm1065 | Borrower, | No | U.S. Return of | |
| | Coborrower | | Partnership | |
| | | | Income [if user | |
| | | | indicates they | |
| | | | are self- | |
| | | | employed at a | |
| | | | partnership or | |
| | | | LLC] | |
| IRSForm1065 (Schedule K-1) | Borrower, | No | IRS Schedule K- | |
| | Coborrower | | 1(Form 1065) [if | |
| | | | user indicates | |
| | | | that they are | |
| | | | self-employed at | |
| | | | a partnership or | |
| | | | LLC] | |
| IRSForm1099 | Borrower, | Yes | IRS 1099 | |
| | Coborrower | | Statements | |
| | | | (including | |
| | | | income | |
| | | | generated from | |
| | | | part-time | |
| | | | employment, | |
| | | | interest on | |
| | | | investments, | |
| | | | dividends) | |
| IRSForm1120 | Borrower, | No | U.S. Corporation | |
| | Coborrower | | Income Tax | |
| | | | Return [if user | |
| | | | indicates they | |
| | | | are self- | |
| | | | employed at C | |
| | | | or S corporation] | |
| LifeInsurancePolicy | Borrower | No | We ask co- | |
| | | | borrower to | |
| | | | represent this for | |
| | | | both themselves | |
| | | | and co- | |
| | | | borrower, so no | |
| | | | co-borrower | |
| | | | required | |
| OtherIncome | Borrower, | Yes | Reporting of | |
| | Coborrower | | other income | |
| | | | from borrower or | |
| | | | co-borrower | |
| OtherSeparationStatement | Borrower, | Yes | Other separation | |
| | Coborrower | | related | |
| | | | expenses | |
| PersonalTaxReturn | Borrower, | Yes | Personal tax | |
| | Coborrower | | returns of self- | |
| | | | employed | |
| | | | borrower or co- | |
| | | | borrowers - two | |
| | | | years required | |
| PrimaryMortgageStatement | Borrower, | Yes | Two most recent | |
| | Coborrower | | primary | |
| | | | mortgage | |
| | | | statements | |
| ProofOfGiftTransfer | n/a | Yes | A letter | If you |
| | | | describing the | have |
| | | | transfer of the | received |
| | | | Gift | a gift |
| ProofOfHomeEquity | Borrower, | No | Since home | If selling |
| | Coborrower | | equity loan, | home to |
| | | | provide proof | finance |
| | | | you own the | purchase |
| | | | home | |
| ProofOfPaystub | Borrower, | Yes | Paystubs | |
| | Coborrower | | | |
| ProofofPropertyPurchaseAgreement | Borrower, | No | Proof of | If you |
| | Coborrower | | purchase | are in |
| | | | agreement for | the |
| | | | sale of property | process |
| | | | used towards | of selling |
| | | | down payment | the |
| | | | | home |
| ProofOfPropertySale | Borrower, | No | Proof of property | If you |
| | Coborrower | | sale used | already |
| | | | towards down | sold the |
| | | | payment | home |
| PropertyTaxStatement | Borrower, | Yes | Property tax | |
| | Coborrower | | statements for | |
| | | | currently owned | |
| | | | properties | |
| RentalAgreementStatement | Borrower, | No | Rental | |
| | Coborrower | | Agreement | |
| | | | specifying | |
| | | | current monthly | |
| | | | rent | |
| RetirementAccountStatement | Borrower, | Yes | Two months | |
| | Coborrower | | | |
| SecondaryMortgageStatement | Borrower, | Yes | with most recent | |
| | Coborrower | | secondary | |
| | | | mortgage | |
| | | | statements (if | |
| | | | applicable) | |
| SeparationAgreement | Borrower, | Yes | Separation or | |
| | Coborrower | | divorce decree | |
| | | | or similar legal | |
| | | | document for | |
| | | | alimony or child | |
| | | | support | |
| | | | payments | |
| SSNCopy | Borrower, | Yes | Copy of | |
| | Coborrower | | borrower and | |
| | | | co-borrower's | |
| | | | SSN | |
| StudentLoanStatement | Borrower, | | Your most | |
| | Coborrower | | recent statement | |
| | | | concerning your | |
| | | | Student Loan | |
| VAEligibilityStatement | Borrower, | No | VA loan | |
| | Coborrower | | Certificate of | |
| | | | Eligibility | |
| VALoanDischargeStatement | Borrower, | No | VA loan DD-214, | |
| | Coborrower | | Discharge | |
| | | | Papers and | |
| | | | Separation | |
| | | | Documents | |
| W2 | Borrower, | Yes | For each | |
| | Coborrower | | employment, | |
| | | | upload the | |
| | | | corresponding | |
| | | | W2 | |
| YTDProfitLossStatement | Borrower, | No | Year-to-date | |
| | Coborrower | | profit/loss | |
| | | | statement for | |
| | | | business of self- | |
| | | | employed | |
| | | | borrower | |

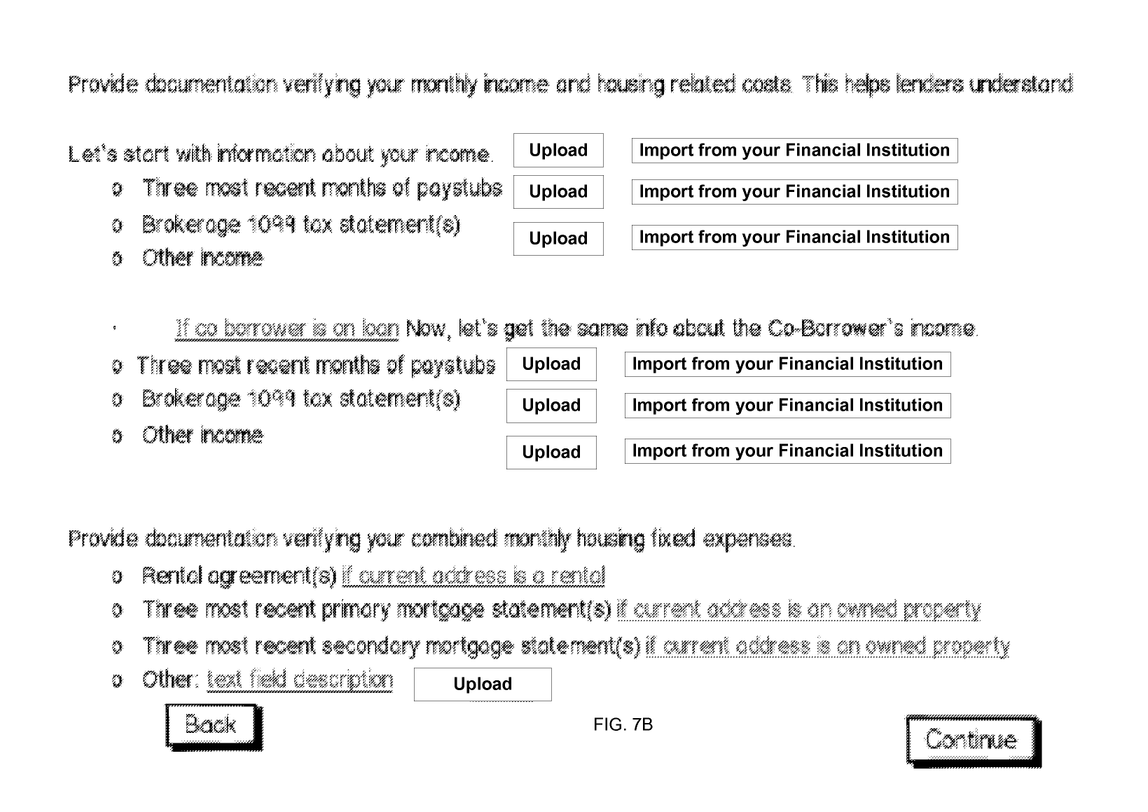

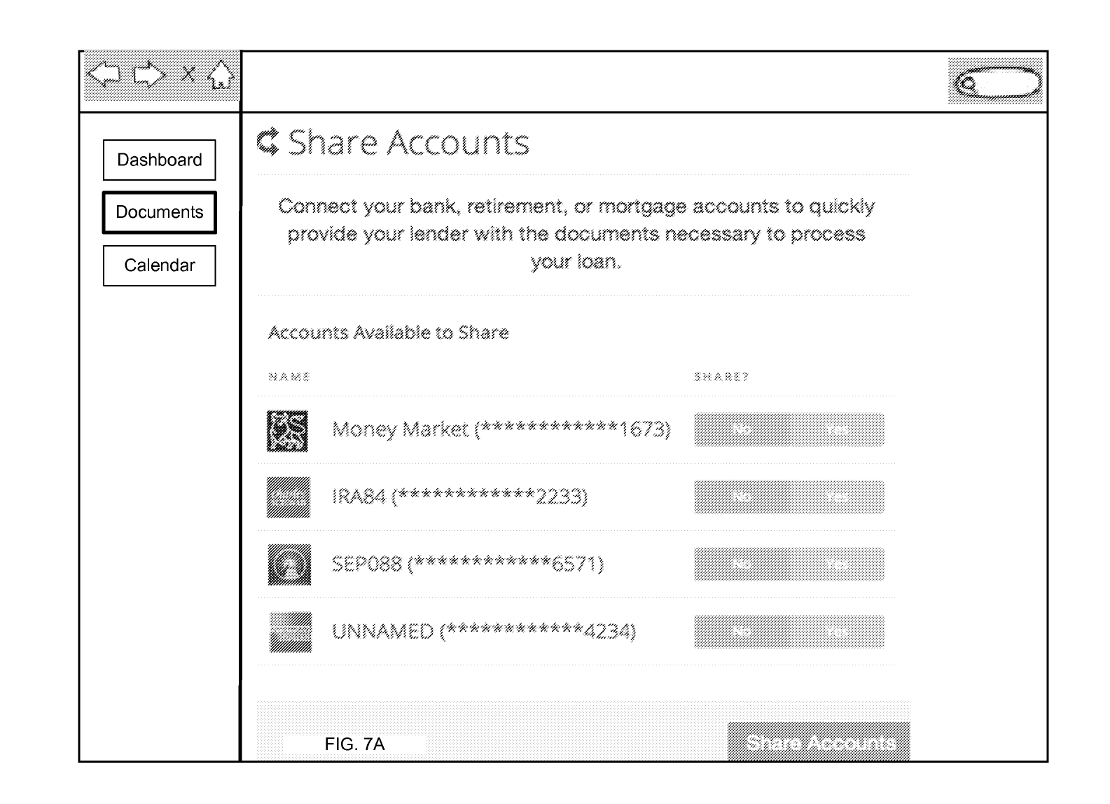

Trigger conditions are associated with each different document type needed for the loan application process in the databases. A routine matches information supplied from the fields and forms to a need to verify the extracted information with a type of documentation. The software service is coded then to present a documents folder with the list of documents needed as well the list with explanations of what types of documents satisfy this requirement. The software service is also coded to present an icon to upload those documents at this time or sometime in the future (also see FIG. 7A).

Immediately after applicant provides information in the mortgage software service, then the algorithm in the routine comes through and reconciles the solicited information from the fields to see the trigger conditions for one or more documents needed based upon the solicited information. The trigger conditions are associated with each different document type needed for the loan application process in the databases, and the algorithm matches information supplied to a need to verify with that type of documentation.

These trigger conditions for the documents can include, for example: if the applicant is applying for a Veterans Administration loan, then the program adds documentation needed from the borrower of their military discharge papers; if the borrower is the owner of the business then the on-line application adds documentation needed from the borrower of their K-1 documentation; if the borrower is an employee of a business, then the on-line application adds documentation needed from the borrower of their W-2 documents from the employer; etc. The table below includes some example trigger conditions to generate the required named documentation.

| | - name: Checking | - name: Checking | | - name: |
|---|---|---|---|---|
| - name: Buyer | Savings Account | Savings Account | name: Drivers | Homeowners |
| Agreement | Statement | Statement | License | Insurance |
| b_cond: | b_cond: true | b_cond: true | b_cond: true | b_cond: |
| a.setting(: property_s | | | | a.owns_property |
| ale_stage, | | | | ?(: b) |
| EMPLOYER_HELD’) | | | | |
| c_cond: false | c_cond: | c_cond: | c_cond: true | c_cond: |
| | Ia.borrower | Ia.coborrower_{—} | | a.owns_property |
| | | spouse | | ?(: c) |
| description: | description: | description: | description: | description: |
| ‘Executed buyout | ‘Checking/savings | ‘Checking/savings | ‘Copy of your | ‘Homeowner |
| plan from an | banking accounts - | banking accounts - | driver's license | Insurance |
| employer relocation | most recent month” | previous month” | or equivalent | statements for |
| program” | | | proof of identity | currently owned |
| | | | (e.g., passport)” | properties |

| | - name: | | | |
|---|---|---|---|---|
| - name: Investment | Investment | - name: IRS Form | - name: IRS | - name: IRS |
| Account Statement | Account Statement | 1065 | Form 1065K1 | Form 1099 |
| b_cond: | b_cond: | b_cond: | b_cond: | b_cond: true |
| Ia.setting(: down_{—} | Ia.setting(: down_{—} | Ia.setting(: b_self_{—} | Ia.setting(: b_{—} | |
| payment_method, | payment_method, | employment, | self_employment, | |
| “INVESTMENT_{—} | “INVESTMENT_{—} | “PARTNERSHIP”) | “PARTNERSHIP”) | |
| ACCOUNT”) | ACCOUNT”) | | | |
| c_cond: | c_cond: | c_cond: | c_cond: | c_cond: true |
| Ia.setting(: down_{—} | Ia.setting(: down_{—} | Ia.setting(: c_self_{—} | Ia.setting(: c_self_{—} | |
| payment_method, | payment_method, | employment, | employment, | |
| “INVESTMENT_{—} | “INVESTMENT_{—} | “PARTNERSHIP”) | “PARTNERSHIP”) | |
| ACCOUNT”) and | ACCOUNT”) and | | | |
| !Ia.borrower | !Ia.coborrower_{—} | | | |
| | spouse | | | |
| description: | description: | description: “IRS | description: | description: |
| “Investment | “Investment | Form 1065 - U.S. | “IRS Schedule | “IRS 1099 |
| account statement - | account statement - | Return of | K-1 (Form | Statements |
| most recent month | previous month” | Partnership | 1065)- | (including |
| | | Income” | Partner’s Share | income |
| | | | of Income” | generated from |
| | | | | part-time |
| | | | | employment, |
| | | | | interest on |
| | | | | investments, |
| | | | | dividends)” |

| | | | name: Other | - name: |
|---|---|---|---|---|
| - name: IRS Form | - name: Life | - name: Mortgage | Separation | Personal Tax |
| 1120 | Insurance Policy | Statement | Statement | Return |
| b_cond: | b_cond: | b_cond: | b_cond: | b_cond: true |
| Ia.setting(: b_self_{—} | Ia.b_life_insurance | Ia.has_mortgage? | Ia.setting(: b_{—} | |
| employment, | | (: b) | marital_status, | |
| “C_CORP”, | | | “SEPARATED”) | |
| “S_CORP”) | | | | |
| c_cond: | c_cond: | c_cond: | c_cond: | c_cond: true |
| Ia.setting(: c_self_{—} | Ia.c_life_insurance | Ia.has_mortgage? | Ia.setting(: c_{—} | |
| employment, | | (: c) | marital_status, | |
| “C_CORP”, | | | “SEPARATED”) | |
| “S_CORP”) | | | | |
| description: “IRS | description: “Life | description: | description: | description: |
| Form 1120 - U.S. | insurance policy | “Mortgage | “Other | “Personal tax |
| Corporation Income | | statements for | separation | returns - most |
| Tax Return” | | your owned | related | recent year” |
| | | properties” | expenses” | |
| | | | - name: Proof | |
| | | | of Property | - name: Proof |
| - name: Proof of | - name: Proof of | | Purchase | of Property |
| Gift Transfer | Home Equity | - name: Pay Stub | Agreement | Sale |
| b_cond: | b_cond: | b_cond: | b_cond: | b_cond: |
| Ia.setting(: down_{—} | Ia.setting(: down_{—} | (Ia.employed?(: b)) | Ia.setting(: | Ia.setting(: |
| payment_method, | payment_method, | | property_sale_{—} | property_sale_{—} |
| ‘FAMILY_GIFT’) | ‘HOME_EQUITY’) | | stage, ‘ESCROW’) | stage, “SOLD”) |
| c_cond: false | c_cond: false | c_cond: | c_cond: false | c_cond: false |
| | | (Ia.employed?(: c)) | | |
| description: “A | description: | description: | description: | description: |
| letter describing the | “Statement of | “Paystubs - most | “Proof of | “Proof of |
| transfer of the Gift” | current home | recent paystub” | purchase | property sale |
| | equity loan (as you | | agreement for | used towards |
| | are using this loan | | sale of property | down payment |
| | to finance your | | used towards | (e.g., HUD-1)” |
| | purchase)” | | down payment” | |
| | - name: VA | - name: VA Loan | | name: YTD |
| - name: Retirement | Eligibility | Discharge | | Profit Loss |
| Account Statement | Statement | Statement | - name: W2 | Statement |
| b_cond: | b_cond: | b_cond: | b_cond: | b_cond: |
| Ia.setting(: down_{—} | Ia.b_va_coe | Ia.b_va_ros? | (Ia.employed?(: | Ia.self_{—} |
| payment_method, | | | b) and | employed?(: b) |
| “RETIREMENT_{—} | | | !Ia.self_{—} | |
| ACCOUNT”) | | | employed?(: b)) | |
| c_cond: | c_cond: | c_cond: | c_cond: | c_cond: |
| Ia.setting(: down_{—} | Ia.c_va_coe | Ia.c_va_ros? | (Ia.employed?(: | Ia.self_{—} |
| payment_method, | | | c) and | employed?(: c) |
| “RETIREMENT_{—} | | | !Ia.self_{—} | |
| ACCOUNT”) and | | | employed?(: c)) | |
| !Ia.coborrower_{—} | | | | |
| spouse | | | | |
| description: | description: “VA | description: “VA | description: | description: |
| “Retirement | Loan Certificate of | Loan DD-214, | “W-2s for each | “Year-to-date |
| Account Statement - | Eligibility | Discharge Papers | employer - | profit/loss |
| most recent | | and Separation | previous year” | statement for |
| month” | | Documents” | | business” |

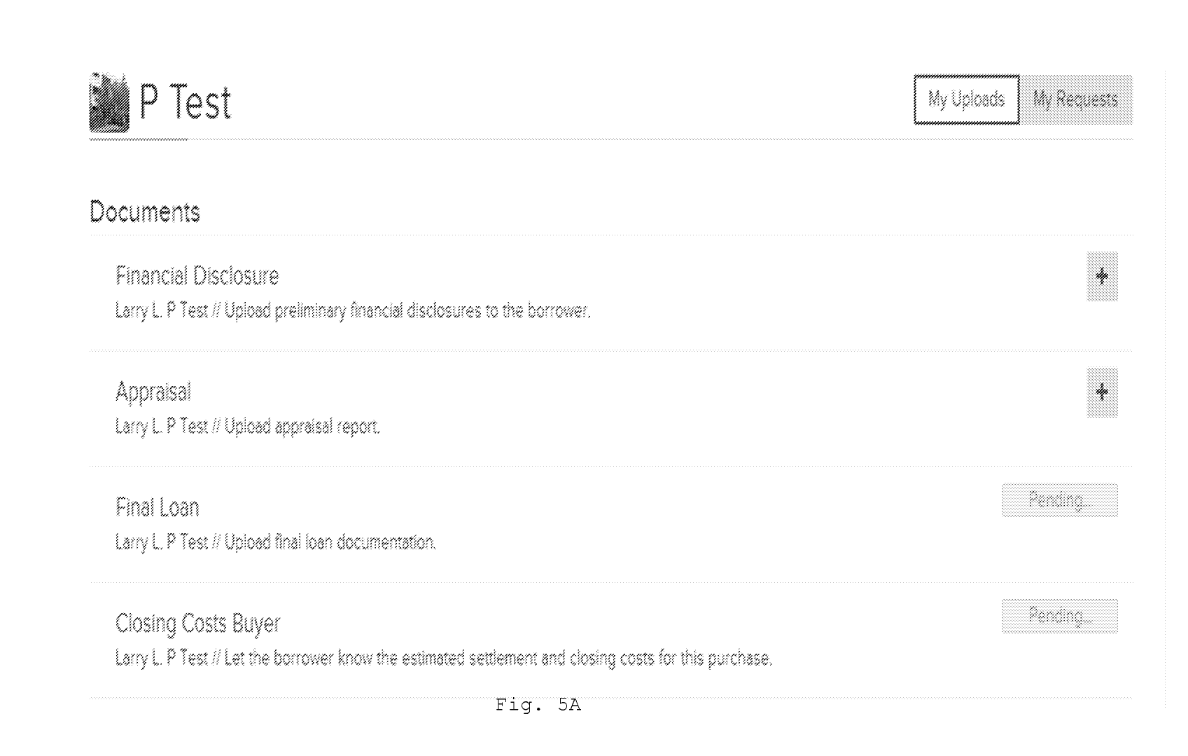

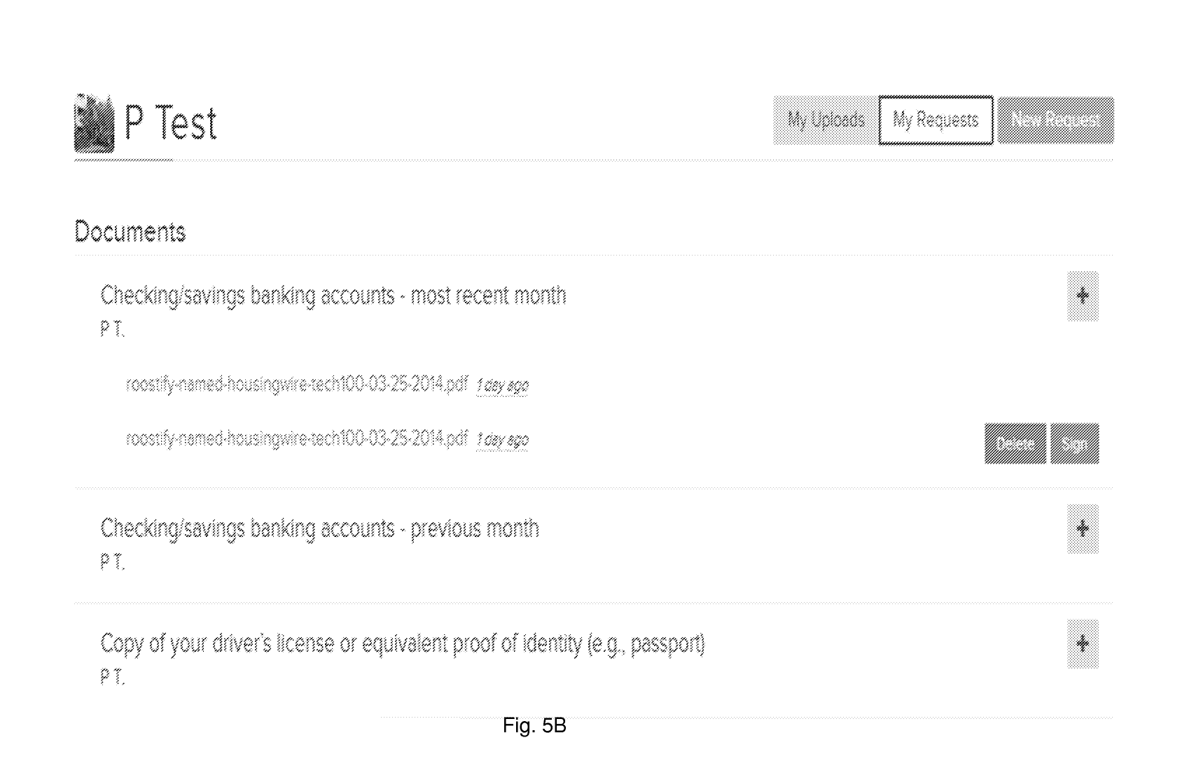

FIGS. 5A & 5B illustrate pages of an embodiment of the cloud-based mortgage software service that conveys borrower documents that have been uploaded as well as additional documents that still need to be uploaded. The cloud-based mortgage software service may present a page with tabs such as “My Uploads” to present documents already uploaded and “My Requests” to indicate documents needing to be uploaded, and “New Request” to convey new or recent requests to the borrower. The cloud-based mortgage software service is coded to automate the mortgage application process by reconciling i) the extracted information to ii) any trigger conditions in the one or more databases associated with the borrower documentation needed from the mortgage guidelines and the investor overlays in the first database to reinforce or verify the extracted information in the fields and forms by the borrower. The routines then generate a list of needed borrower documents that will be needed by the underwriter based on the guidelines of the government-sponsored lending institutions and the overlays required by direct lending corporations. The cloud-based mortgage software service is coded to then present the list of borrower documents currently uploaded and borrower documents still needed on a display screen of the client device, such as the “My Request” tab and the “My Uploads” tab. This documents page of the software service has both i) an upload icon to upload a file as well as a ii) a linked accounts icon (for example, see FIG. 7A) to allow the borrower to securely connect another online account of the borrower in order to allow a borrower to authenticate themselves to their online account quickly originate a request to the online account to share the borrower's account information with the provider site to obtain information and documents necessary to process the borrower's loan that may satisfy one or more requests for documentation in lieu of or supplemental to documents uploaded directly by the borrower.

The software service is coded to also generate an electronic notification, including e-mail, text message, or other notification to a borrower's e-mail account or phone number with notification regarding about missing documents still needed by the underwriter. The New Request tab can also list out notifications regarding the loan including any new missing documents. Thus, the loan officers can send notifications to and requests of the borrower through the software service to the borrower to close an approved loan. The borrower can then provide any requested information and documentation via pages presented by the software service.

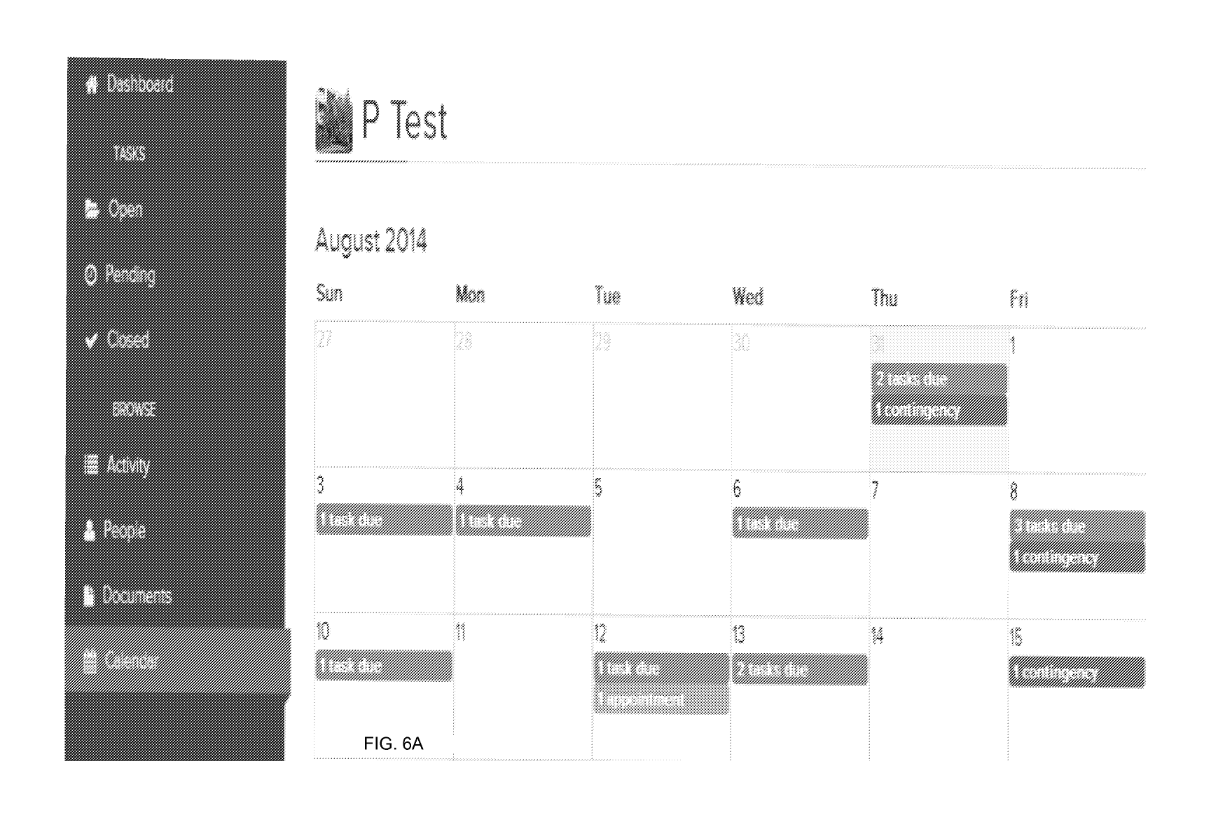

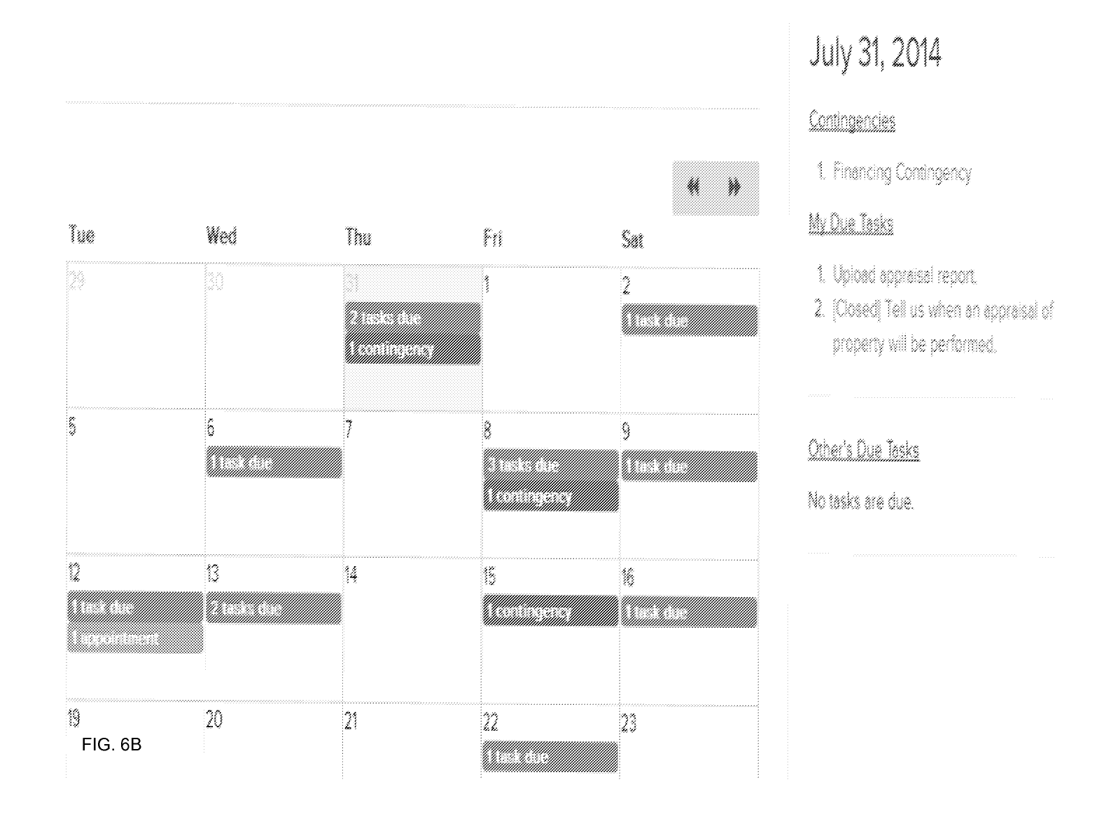

FIGS. 6A and 6B illustrate calendar pages of an embodiment of the cloud-based mortgage software service that conveys when tasks are due, appointments exist, etc. The calendar folder of the software service has a shared calendar. The software service has a calendar that tracks activity dates associated with the loan approval and loan and real estate closing process and shares the tracked activity on the calendar when actions occur by a lender regarding the loan, which allows a borrower viewing the calendar to instantly let the borrower know what is a status of the loan approval and what to expect in the closing process as well as to convey when the next steps in the loan and real estate closing process are expected to occur. The cloud-based mortgage software service lets loan officers and home buyers share and track critical information seamlessly. The cloud-based mortgage software service lists documents submitted and whether they satisfy the requirements and actual dates on a calendar of when process is made on the loan application.

The software service has a routine coded to detect when the person makes an activity occur regarding the loan approval or closing process. The activity could include things such as i) the borrower provides a document or other information through the mortgage software service; ii) when the loan officer makes an entry on the calendar; and other similar activities. The routine is coded to provide at least the borrower and the loan officer with an electronic notification to their phone or e-mail account information extracted from the people tab page when this activity occurs regarding the loan approval or closing process.

The calendar also tells the borrower what is outstanding/tasks due in the process. The software service know what is outstanding by reviewing and/or extracting the information already provided by the borrower, as well as calendaring when a due date associated with a task from the borrow or task from the loan agent is due.

The calendar provides a borrower and their agent with automatic notifications and 24 hours a day and 7 days a week visibility into the loan application and real estate closing activities.

The cloud-based mortgage software service lets loan officers and borrowers seamlessly share and track critical information in the mortgage application and closing process. The secure interface improves client responsiveness and reduces cycles for loan officers, while giving buyers visibility into every step of their loan and home closing, prevents delays in the overall contract-to-closing process.

FIGS. 7A and 7B illustrate pages of an embodiment of the cloud-based mortgage software service that allow a borrower to establish a link between the software service and one or more institutions that contain information or maintain an account for the borrower. The cloud-based mortgage software service has an interface coded to interact and cooperate with a third party interface so that a borrower may authenticate themselves with one or more online information institutions so that a borrower's financial information and documentation stored in that online information institution can be requested by the software service and in response to the request, then the online information institution can electronically send the documentation on a borrower's assets over the network via a secure tunnel from the online information institution of the borrower to the provider site. Note, example online information institutions includes online financial institutions, information companies such as turbo tax, Facebook, etc., and on-line verification institutions. Also, the mortgage software service is coded to accept verified data corresponding to the data found in an actual document in lieu of needing to upload the actual document itself.

Referring to FIG. 7A, the software service can lead a borrower through the documentation needed for the loan and present the needed documentation and a mechanism to provide that documentation, such as uploading the documentation or importing the information from a third party institution. For example, the software service can request the borrower to provide documentation verifying their monthly income, verifying the co-borrower's monthly income, verifying their monthly housing related costs, etc.

The cloud-based mortgage software service presents then a list of borrower documentation needed to verify the information inputted by the mortgage applicant/borrower. The borrower can activate/press an icon that says “upload” next to each of the presented documents in order to upload the corresponding borrower's document, i.e., W-2, K-1, residence information document, identity information document, etc. securely to the cloud site via the secure software, such as a Hypertext Transfer Protocol Secure (HTTPS) communications protocol. The software creates a secure tunnel/channel over an insecure network between the user's client device and the cloud server-site.

Referring to FIG. 7A, each listed document also has an additional button on the page configured to establish a link between the cloud site and the borrower's financial institution site. Referring to FIG. 7B, the link button is coded to establish a secure link, send a request for the required documentation, and upon its receipt automatically originate a request to send the required documentation from the borrower's financial institution to the lending corporation via the mortgage software service. Thus, the automated mortgage software service has an interface that allows the mortgage software service to interface with financial institutions so that this information can be electronically generated and submitted from directly from the financial institution, including banking accounts, checking accounts, 401(k)s, etc. and have that information sent directly via the secure link from the financial institution into mortgage software service website or even directly to the lending corporation via the mortgage software service.

Documents uploaded into the mortgage software service's site for storage are stored securely and the documentation is submitted to the two or more direct lending corporations via the secure link.

FIG. 8 illustrates a page of an embodiment of the mortgage software service that presents an application programming interface used to export information from the mortgage software service. The cloud-based mortgage software service has one or more application programming interfaces with the two or more direct lending institutions to load the documentation and loan application forms into a database of that direct lending institution. Each application programming interface of the software service is coded to export the loan application information as generic data, such as in a Fannie Mae formatted file, and send accompanying documentation as an electronic document in standard readable format, such as a .PDF, across a secure communication channel to the database of that direct lending institution. An application programming interface of the software service is coded to export the loan application information and accompanying documentation by understanding and mapping the semantics of direct lender's system and exporting the loan application information and accompanying documentation with the names and nomenclature used by the direct lender's system.

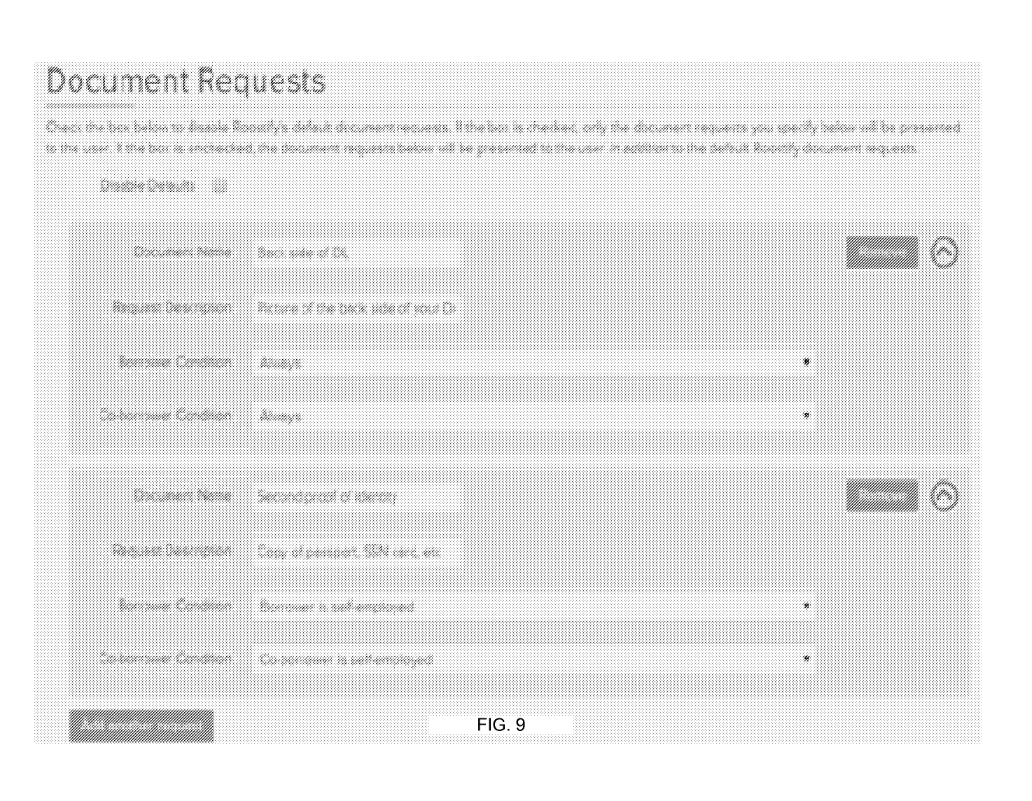

FIG. 9 illustrates a page of an embodiment of the mortgage software service that presents a graphic user interface to allow one or more direct lending institutions as well as other institutions to customize exports information from the software service into their institution. The mortgage software service is configured to present a graphic user interface to the one or more direct lending institutions as well as other on-line institutions to allow these institutions to customize in what fields and formats the application programming interface of the software service exports information from the software service into a system used by that institution so that merely minor changes, if any, are required for the system in that institution to use the exported information.

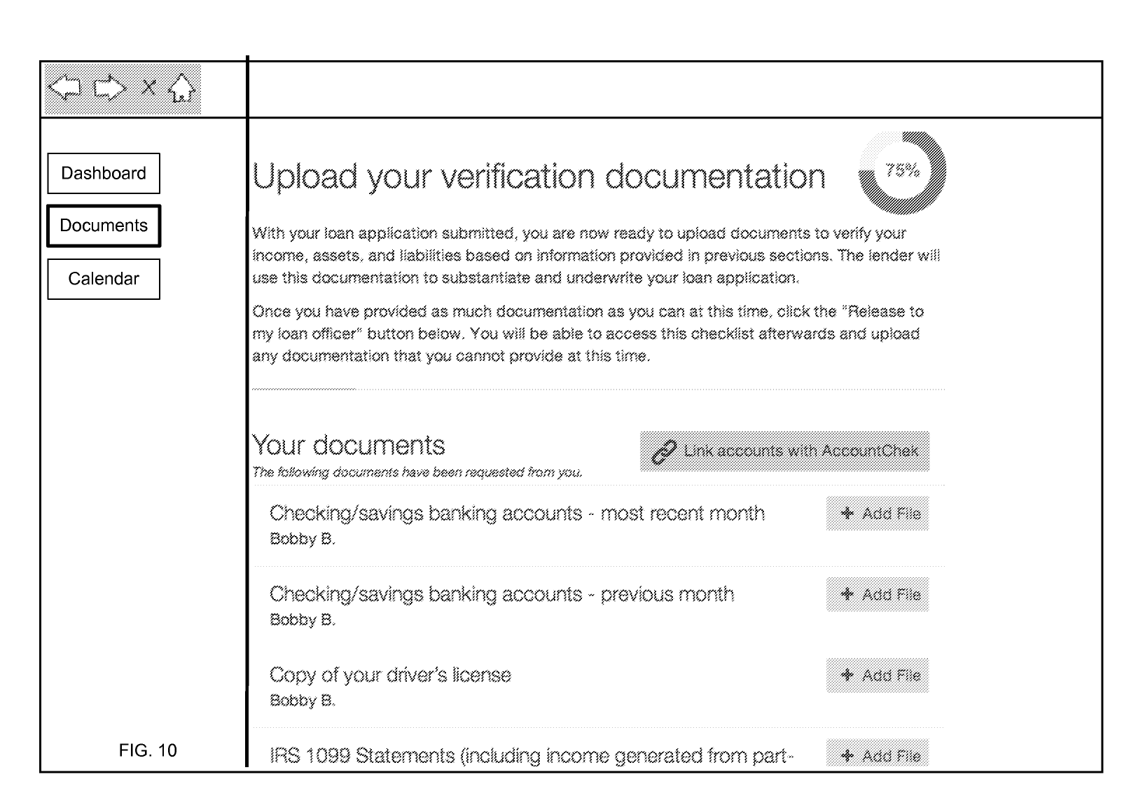

FIG. 10 illustrates a page of an embodiment of the cloud-based mortgage software service coded to present the list of needed borrower documents and the borrower can activate the upload icon in order to upload the corresponding borrower's document securely to the provider site. The software service is coded to submit the complete loan application and accompanying documentation when the entire application and all accompanying documents can be submitted, which should increase conversion rates of applications into approved loans because the submitted complete loan application will have both the required information solicited as well as all of the needed borrower documentation to approve the loan. The cloud-based mortgage software service is coded to have application programming interfaces with direct lending corporations and establishes a secure communication channel to a server site for at least one of the different lending institutions in order to send the borrower's loan application with all required forms and accompanying documentation at a start of loan process to that direct lending corporation. A secure tunnel is established over the network between the client device and the provider site via an identity of both a sending device and a receiving device are verified in a secure exchange of information through the secure tunnel. The cloud-based mortgage software service is completely secure, reducing the risk of sensitive information being compromised.

The cloud-based mortgage software service help lenders increase conversion of loan applications into closed loans. The cloud-based mortgage software service gives benefits that include, the conversion rates of applications into approved loans will increase because it's easier to qualify for the loans because the submitted loan application will have both the required information solicited as well as all of the needed borrower documentation to approve the loan. The cloud-based mortgage software service is coded to solicit and communicate this information to the borrower and then the mortgage software service passes this submitted documentation securely along with the application to two or more different lending institutions.

Electronically submitting this information and borrower documentation to one or more lending institutions automates the initial intake process to provide the information and documentation that the underwriter at the lending institution needs; thereby, removing hours of labor from employees of the lending institution having to gather this information and upload this information into a database themselves. The cloud-based mortgage software service has one or more application programming interfaces with the one or more lending institutions to load the documentation and borrower information into the database of each lending institution. The application programming interface of the software service allows the loan application information and accompanying documentation to be sent as generic data and accompanying standard electronic documents into multiple different mortgage lender's computer systems.

In an embodiment, the loan process cycle should go faster/speed up because the documentation needed for the underwriter to approve the loan based on the investor overlays that they want to see and the guidelines provided by Fannie Mae will accompany the loan application. Thus, the cloud-based mortgage software service is coded to significantly speed up the typical process of getting a mortgage application own for residential property.

The cloud-based mortgage software service is coded to stream line the mortgage application process by the following manner. The cloud-based mortgage software service directly supplies the borrower's information and documentation to reduce the amount of time that the lender's employees have to spend in order to approve a loan. Traditionally, an agent for the mortgage applicant/borrower will collect the information of the mortgage loan application from the borrower and send that information into the lending corporation. The lending corporation will then have their employees upload that information into their system electronically and see if the mortgage applicant qualifies for the loan. If so, then the lending company will send back to the agent a request to obtain an initial round of documentation for the underwriter. The mortgage applicant will then, at that point, send in documentation for the underwriter to review and verify the loan application information for a first round of documentation with the underwriter. The underwriter that is assigned to review that documentation will generally ask for a second round of documentation based upon what that underwriter subjectively feels new additional documentation is needed to satisfy the Fannie Mae guidelines and investor overlay requirements. However, the cloud-based mortgage software service automates this loan process by presenting fields or other mechanisms to fill out the application and has an application programming interface that allows that solicited information to be fed virtually directly into the lender's electronic systems.

Also, the cloud-based mortgage software service will send in an initial round of documentation needed for the underwriter based on the Fannie Mae guidelines and investor overlay requirements. The cloud-based mortgage software service also enforces an objective compliance with the one or more government-sponsored lending institutions requirements and direct lender investor overlays requirements. The cloud-based mortgage software service proving information and documentation that should objectively satisfy most underwriter's requirements and makes it more of an objective compliance with those two guidelines rather than a subjective decision-making process by the underwriter on what kind of documentation may or may not be needed.

Consumers can use mobile apps to shop for loans online, track loan status, receive notifications about missing documents needed, as well as other tasks like accessing mapping software to get directions to the title company. This helps support loan officers' relationships with borrowers, as well as with their business and real estate agent referral partners. Apps also generally pair the consumer interface with an equivalent one for their real estate agent.

### Computing System

FIG. 1 illustrates a block diagram of an example computing system that may use an embodiment of one or more of the software applications discussed herein. The computing system environment 800 is only one example of a suitable computing environment, such as a client device, and is not intended to suggest any limitation as to the scope of use or functionality of the design. Neither should the computing environment 800 be interpreted as having any dependency or requirement relating to any one or combination of components illustrated in the exemplary operating environment 800.

As discussed, the computing system may be a client mobile computing system. The system includes a processor, a memory, a built in battery to power the mobile computing device, a built-in video camera, a display screen for the mobile computing device, and built-in Wi-Fi circuitry to wirelessly communicate with a server computer connected to network. In regards of viewing ability of this on-line site: this on-line has code to be adapted to be viewed on tablets and mobile phones, such as individual downloadable applications in data stores that are designed to interface with the on-line site, as well as by a desktop computer with a browser. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like.

The design is operational with numerous other general purpose or special purpose computing system environments or configurations. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The design is also described in the general context of computing device executable instructions, such as program modules etc. being executed by a computer. Generally, program modules include routines, programs, objects, applications, widget, plug-ins, and other similar structures that perform particular tasks or implement particular abstract data types. Those skilled in the art can implement the description and/or figures herein as computer-executable instructions, which can be embodied on any form of computing machine readable media discussed below.

The design may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary computing type system for implementing the design includes a general-purpose computing device in the form of a computer 810. Components of computer 810 may include, but are not limited to, a processing unit 820 having one or more processing cores, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computer 810 typically includes a variety of computing machine readable media. Computing machine readable media can be any available media that can be accessed by computer 810 and includes both volatile and nonvolatile media, removable and non-removable media. By way of example, and not limitation, computing machine readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computer 800. However, carrier waves would not fall into a computer readable medium. Communication media typically embodies computer readable instructions, data structures, program modules, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 1 illustrates operating system 834, program modules 836, and program data 837.

The computer 810 may also include other removable/non-removable volatile/nonvolatile computer storage media. By way of example only, FIG. 1 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 1, provide storage of computer readable instructions, data structures, program modules and other data for the computer 810. In FIG. 1, for example, hard disk drive 841 is illustrated as storing operating system 844, program modules 846, and program data 847. Note that these components can either be the same as or different from operating system 834, program modules 836, and program data 837. Operating system 844, program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A display monitor 891 or other type of display screen device is also connected to the system bus 821 via an interface, such as a video interface 890. In addition to the monitor, computers may also include other peripheral output devices such as speakers 897 and printer 896, which may be connected through an output peripheral interface 890.

The computer 810 may operate in a networked environment using logical connections to one or more remote computers/client devices, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 1 include a local area network (LAN) 871 and a wide area network (WAN) 873, but may also include other networks. Such networking environments are commonplace in offices, enterprise-wide computer networks, intranets and the Internet. A browser application may be resident on the computing device and stored in the memory.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user-input interface 860, or other appropriate mechanism. In a networked environment, program modules depicted relative to the computer 810, or portions thereof, may be stored in the remote memory storage device. By way of example, and not limitation, FIG. 1 illustrates remote application programs 885 as residing on remote computer 880. It will be appreciated that the network connections shown are exemplary and other means of establishing a communications link between the computers may be used.

It should be noted that the present design can be carried out on a computing system such as that described with respect to FIG. 1. However, the present design can be carried out on a server, a computer devoted to message handling, or on a distributed system in which different portions of the present design are carried out on different parts of the distributed computing system.

Another device that may be coupled to bus 811 is a power supply such as a battery and Alternating Current adapter circuit. As discussed above, the DC power supply may be a battery, a fuel cell, or similar DC power source that needs to be recharged on a periodic basis. The wireless communication module 872 may employ a Wireless Application Protocol to establish a wireless communication channel. The wireless communication module 872 may implement a wireless networking standard such as Institute of Electrical and Electronics Engineers (IEEE) 802.11 standard, IEEE std. 802.11-1999, published by IEEE in 1999.

While other systems may use, in an independent manner, various components that may be used in the design, a comprehensive, integrated system that addresses the multiple advertising system points of vulnerability described herein does not exist. As described, examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

### Network Environment

FIG. 2 illustrates a diagram of a network environment in which the techniques described may be applied. The network environment 200 has a network 202 that connects server computing systems 204-1 through 204-n, and at least one or more client computing systems 200-1. As shown, there may be many server computing systems 204-1 through 204-n and many client computing systems 200-1 through 200-n connected to each other via a network 220, which may be, for example, the Internet. Note, that alternatively the network 220 might be or include one or more of: an optical network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 200-1 and the server computing system 204-1 can both initiate and respond to communications, their communication may be viewed as peer-to-peer. Likewise, communications between the client computing systems 204-1 and 204-2, and the server computing systems 200-1 and 200-2 may be viewed as peer-to-peer if each such communicating device is capable of initiation and response to communication. One or more of the server computing systems 204-1 to 204-n may be associated with a database such as, for example, the databases 206-1 to 206-n. A firewall such as, for example, the firewall may be established between a client computing system 200-3 and the network 220 to protect data integrity on the client computing system 200-3.

In an embodiment, the server computing system 204 may include a server engine, a web page management component, a content management component and a database management component. The server engine performs basic processing and operating system level tasks. The web page management component handles creation and display or routing of web pages or screens associated with receiving and providing digital content and digital advertisements. Users may access the server computer by means of a URL associated therewith. The content management component handles most of the functions in the embodiments described herein. The database management component includes storage and retrieval tasks with respect to the database, queries to the database, and storage of data.

A cloud provider service can install and operate application software in the cloud and users can access the software service from client devices. Cloud users generally do not manage the cloud infrastructure and platform where the application runs. Cloud applications can be different from other applications in their scalability—which can be achieved by cloning tasks onto multiple virtual machines at run-time to meet changing work demand. Load balancers distribute the work over the set of virtual machines. This process is transparent to the cloud user, who sees only a single access point. The cloud-based mortgage software service may uses an intelligent key management system to help secure their data on the cloud-based provider site.

FIG. 2 also illustrates a block diagram of an embodiment of a server computing system to display information, such as a web page, etc. An application including any program modules, when executed on the server computing system 204-1, causes the server computing system 204-1 to display windows and user interface screens on a portion of a media space, such as a web page. A user via a browser from the client computing system 200-1 may interact with the web page, and then supply input to the query/fields and/or service presented by a user interface of the application. The web page may be served by a web server computing system 204-1 on any Hypertext Markup Language (HTML) or Wireless Access Protocol (WAP) enabled client computing system 200-1 or any equivalent thereof. For example, the client mobile computing system 200-1 may be a smart phone, a touch pad, a laptop, a netbook, etc. The client computing system 200-1 may host a browser to interact with the server computing system 204-1. Each application has a code scripted to perform the functions that the software component is coded to carry out such as presenting fields and icons to take details of desired information. Algorithms, routines, and engines within the server computing system 204-1 take the information from the presenting fields and icons and put that information into an appropriate storage medium such as a database. A comparison wizard is scripted to refer to a database and make use of such data. The applications may be hosted on the server computing system 204-1 and served to the browser of the client computing system 200-1. The applications then serve pages that allow entry of details and further pages that allow entry of more details.

Any application and other scripted code components may be stored on a non-transitory computing machine readable medium which, when executed on the server causes the server to perform those functions. The applications including program modules may be implemented as logical sequences of software code, hardware logic circuits, and any combination of the two, and portions of the application scripted in software code are stored in a non-transitory computing device readable medium in an executable format. In an embodiment, the hardware logic consists of electronic circuits that follow the rules of Boolean Logic, software that contain patterns of instructions, or any combination of both.

Some portions of the detailed descriptions which follow are presented in terms of algorithms/routines and symbolic representations of operations on data bits within a computer memory. These algorithmic descriptions and representations are the means used by those skilled in the data processing arts to most effectively convey the substance of their work to others skilled in the art. An algorithm/routine is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms/routine of the application including the program modules may be written in a number of different software programming languages such as C, C++, Java, HTML, or other similar languages.

Many pages are written using the same language, Hypertext Markup Language (HTML), which is passed around using a common protocol—HTTP. HTTP is the common internet language (dialect, or specification). Through the use of a web browser, a special piece of software that interprets HTTP and renders HTML into a human-readable form, web pages authored in HTML on any type of computer can be read anywhere, including telephones, PDAs and even popular games consoles. Because of HTTP, a client machine (like your computer) knows that it has to be the one to initiate a request for a web page; it sends this request to a server. A server is a computer where web sites reside—when you type a web address into your browser, a server receives your request, finds the web page you want, and sends it back to your computer to be displayed in your web browser. The client device and server may bilaterally communicate via a HTTP request & response cycle between the two.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

Although embodiments of this design have been fully described with reference to the accompanying drawings, it is to be noted that various changes and modifications will become apparent to those skilled in the art. Such changes and modifications are to be understood as being included within the scope of embodiments of this design as defined by the appended claims. The invention is to be understood as not limited by the specific embodiments described herein, but only by scope of the appended claims.

1. An apparatus, comprising:
a cloud-based mortgage software service hosted on a cloud-based provider site that contains one or more servers and one or more databases, where the cloud-based mortgage software service is coded to utilize a protocol, including HTTP, to engage in a request and response cycle with both a mobile device application resident on a client device as well as a web-browser application resident on the client device, where the cloud-based mortgage software service has one or more routines to automate a residential mortgage application process by i) presenting a combination of fields, forms, and pages to solicit information from a borrower using the client device for a residential mortgage loan application and then ii) applying logic to extract information put into the fields and forms by the borrower and iii) comparing that extracted information to some information on trigger conditions for borrower documents stored in the one or more databases, where the mortgage software service is coded to then return a list of documents that present one or more icons to activate an upload routine to upload a plurality of borrower's documents over a network from the client device into the one or more databases, where a first database in the one or more databases is also configured to contain and index information regarding i) mortgage guidelines and requirements for residential mortgage loans, including any accompanying borrower's documentation needed, from one or more government-sponsored lending institutions as well as ii) any additional information from one or more direct lending corporations, where the additional information includes requirements from investor overlays and any additional documentation requirements needed to supply a complete loan application to an underwriter of that direct lending corporation to approve the loan application, where the cloud-based mortgage software service is coded to automate the mortgage application process by reconciling i) the extracted information to ii) any trigger conditions in the one or more databases associated with the borrower documentation needed from the mortgage guidelines and the investor overlays in the first database to reinforce or verify the extracted information in the fields and forms by the borrower, where the routines are coded to then generate a list of needed borrower documents that will be needed by the underwriter based on the guidelines of the government-sponsored lending institutions and the overlays required by direct lending corporations, where the cloud-based mortgage software service is coded to then present the list of borrower documents currently uploaded and borrower documents still needed on a display screen of the client device, where the cloud-based mortgage software service can be implemented in software, hardware electronics, and any combination of both and when one or more portions of the system are implemented in software, then that software is tangibly stored in an executable format on the one or more non-transitory storage mediums.

2. The apparatus of claim 1, where the cloud-based mortgage software service is coded to present a series of page templates each with a different function, where the pages include, but will not be limited to, a welcome page, a borrower's page, a co-borrower page, an employment page, an income page, an assets and liabilities page, a loan page, a declarations page, a people tab page to collect and list people involved in a loan process and closing process along with their contact information, and a loan application release form, where the cloud-based mortgage software service generates a customized workflow process for each individual borrower utilizing this software service based on the information being solicited out of the fields and forms of the cloud-based mortgage software service, which the extracted information then causes the triggering of conditions associated with the borrower documentation needed for the underwriter as well as the mortgage software service to present any additional on-line forms to be filled out by the borrower based on the trigger conditions.

3. The apparatus of claim 2, where the cloud-based mortgage software service has one or more application programming interfaces with two or more of the direct lending institutions and is also coded to establish a secure communication link between each direct lending institutions and the provider site, where the mortgage software service is coded to establish the secure communication link by creating a tunnel at the socket layer and encrypting any data while in transit between each direct lending institutions and the provider site as well as to satisfy any additional authentication mechanisms required by the direct lending institution, including but not limited to IP address white listing and token based authentication, where the mortgage software service has a calendar that tracks activity dates associated with the loan approval and loan and real estate closing process and shares the tracked activity on the calendar when actions occur by a lender regarding the loan, which allows a borrower viewing the calendar to instantly let the borrower know what is a status of the loan approval and what to expect in the closing process as well as to convey when the next steps in the loan and real estate closing process are expected to occur, and where loan officers can also send notifications to and requests of the borrower through the mortgage software service to the borrower to close an approved loan, where the borrower can provide any requested information and documentation via pages presented by the software service, where the mortgage software service has a first routine coded to detect when the person makes an activity occur regarding the loan approval or closing process, where the activity includes i) the borrower providing a document or other information through the mortgage software service and ii) when the loan officer makes an entry on the calendar, then the first routine is coded to provide at least the borrower and the loan officer with an electronic notification to their phone or e-mail account information extracted from the people tab page when this activity occurs regarding the loan approval or closing process.

4. The apparatus of claim 1, where a second database of the one or more databases indexes and contains one or more trigger conditions that trigger the need for the documentation needed by the mortgage guidelines of government-sponsored lending institutions and the overlays of the direct lending corporations, where the first database contains and indexes i) documentation needed under every possible situation for a loan approval from the government-sponsored lending institutions underneath its mortgage guidelines as well as ii) all of the potential documentation needed based on the investor overlays from the two or more the direct lending institutions, where an application programming interface in the mortgage software service allows each direct lending institution to create multiple instances of investor overlays to be applied regarding that direct lending institution based on information including but not limited to i) a type of loan being requested, ii) an amount of the loan being requested, iii) an amount of assets or income of the borrower requesting the loan, iv) employment history, v) credit history, vi) asset history, vii) and any other borrower liabilities including alimony and child support, and vii) any combination of these factors, where after a first routine of the software service reconciles the extracted information against the conditions that triggered the borrower documentation needed, then the cloud-based mortgage software service will generate and post a list of documentation that will be needed from this particular borrower for the loan based on their extracted information.

5. The apparatus of claim 4, where the trigger conditions are associated with each different document type needed for the loan application process in the databases, and the first routine matches information supplied from the fields and forms to a need to verify the extracted information with a type of documentation, and where the software service is coded to present a documents folder with the list of documents needed as well the list with explanations of what types of documents satisfy this requirement, where the software service is coded to present an icon to upload those documents at this time or sometime in the future, where the software service is coded to submit the complete loan application and accompanying documentation when the entire application and all accompanying documents can be submitted, which should increase conversion rates of applications into approved loans because the submitted complete loan application will have both the required information solicited as well as all of the needed borrower documentation to approve the loan, where the cloud-based mortgage software service is coded to have application programming interfaces with direct lending corporations and establishes a secure communication channel to a server site for at least one of the different lending institutions in order to send the borrower's loan application with all required forms and accompanying documentation at a start of loan process to that direct lending corporation.

6. The apparatus of claim 1, where the software service has a documents folder with the list of borrower documents currently uploaded and borrower documents still needed, and that page of the software service has both i) an upload icon to upload a file as well as ii) a linked accounts icon to allow the borrower to securely connect another online account of the borrower in order to allow a borrower to authenticate themselves to their online account quickly originate a request to the online account to share the borrower's account information with the provider site to obtain information and documents necessary to process the borrower's loan that may satisfy one or more requests for documentation i) in lieu of, or ii) supplemental to documents uploaded directly by the borrower, and where the software service also has a calendar that tracks activity dates associated with the loan approval and closing process and shares the tracked activity on the calendar when actions occur by a lender regarding the loan to let the borrower know what is a status of the loan approval and what to expect in the closing process.

7. The apparatus of claim 1, where the cloud-based mortgage software service has one or more application programming interfaces with the one or more direct lending institutions to load the documentation and loan application forms into a database of that direct lending institution, where each application programming interface of the software service is coded to export the loan application information as generic data, including a Fannie Mae formatted file, and send accompanying documentation as an electronic document in standard readable format across a secure communication channel to the database of that direct lending institution, where the loan application information and accompanying documentation of the borrower are stored in an encrypted form while stored in the one or more databases of the provider site, where the mortgage software service is configured to present a graphic user interface to the one or more direct lending institutions as well as other on-line institutions to allow these institutions to customize in what fields and formats the application programming interface of the software service exports information from the software service into a system used by that institution so that merely minor changes, if any, are required for the system in that institution to use the exported information.

8. The apparatus of claim 1, where the cloud-based mortgage software service has an interface coded to interact and cooperate with a third party interface so that a borrower may authenticate themselves with one or more online information institutions so that a borrower's financial information and documentation stored in that online information institution can be requested by the software service and in response to the request, then the online information institution can electronically send the documentation on a borrower's assets over the network via a secure tunnel from the online information institution of the borrower to the provider site, where an application programming interface of the software service is coded to export the loan application information and accompanying documentation by understanding and mapping the semantics of direct lender's system and exporting the loan application information and accompanying documentation with the names and nomenclature used by the direct lender's system.

9. The apparatus of claim 1, where the cloud-based mortgage software service is coded to present a document folder with the list of needed borrower documents that will be needed by the underwriter, then the borrower can activate an icon next to each of the presented document requests customized for that borrower, and the borrower can activate the upload icon in order to upload the corresponding borrower's document securely to the provider site via a secure tunnel over the network between the client device and the provider site, where an identity of both a sending device and a receiving device are verified in a secure exchange of information through the secure tunnel, where the software service is coded to also generate an electronic notification, including e-mail, text message, or other notification to a borrower's e-mail account or phone number, where the electronic notification regards missing documents still needed by the underwriter.

10. The apparatus of claim 1, where the cloud-based mortgage software service has one or more application programming interfaces and is coded to establish a secure communication link with two or more on-line financial institutions, has one or more application programming interfaces with two or more direct lender's loan origination systems and is coded to establish a secure communication link with the direct lender's loan origination systems, and one or more application programming interfaces with one or more asset verification sites with a secure communication link between the asset verification site and the provider site in order to allow a borrower's assets entered into the field and forms of the software service to be verified by the asset verification site, and then mortgage software service is configured to receive the verification of the borrower's assets from the asset verification site, which then the software service exports the verification of a borrower's assets to the direct lender's loan origination system, wherein the cloud based mortgage software service is a middle support service interconnecting the on-line financial institutions, the direct lender's loan origination systems, and the asset verification sites.

11. A method for cloud-based mortgage software service hosted on a cloud-based provider site that automates a residential mortgage application process, comprising:
configuring the cloud-based mortgage software service to be hosted on the cloud-based provider site that contains one or more servers and one or more databases;
configuring the cloud-based mortgage software service to utilize a protocol to engage in a request and response cycle with both a mobile device application resident on a client device as well as a web-browser application resident on the client device;
configuring the cloud-based mortgage software service to have one or more routines to automate the residential mortgage application process by i) presenting a combination of fields, forms, and pages to solicit information from a borrower using the client device for a residential mortgage loan application then applying logic to extract information put into the fields and forms by the borrower and comparing that extracted information to some information on trigger conditions for borrower documents stored in the one or more databases, and then ii) returning a list of documents that present one or more icons to activate an upload routine to upload a plurality of borrower's documents over a network from the client device into the one or more databases;
configuring a first database to contain and index information regarding i) mortgage guidelines and requirements for residential mortgage loans, including any accompanying borrower's documentation needed from one or more government-sponsored lending institutions as well as ii) any additional information from one or more direct lending corporations, where the additional information includes requirements from investor overlays and any additional documentation requirements needed to supply a complete loan application to an underwriter of that direct lending corporation, such as a bank or credit union, to approve the loan application;
configuring the cloud-based mortgage software service to automate the mortgage application process by reconciling i) the extracted information to ii) any trigger conditions in the database associated with the borrower documentation needed from the mortgage guidelines and the overlays to reinforce or verify the extracted information in the fields and forms by the borrower, and then generate a list of needed borrower documents that will be needed by the underwriter based on the guidelines of the government-sponsored lending institutions and the overlays required by direct lending corporations; and
configuring the cloud-based mortgage software service to then present the list of borrower documents currently uploaded and borrower documents still needed on a display screen of the client device, where the cloud-based mortgage software service can be implemented in software, hardware electronics, and any combination of both and when one or more portions of the system are implemented in software, then that software is tangibly stored in an executable format on the one or more non-transitory storage mediums.

12. The method of claim 11, further comprising:
configuring the cloud-based mortgage software service to present a series of page templates each with a different function, where the pages include, but will not be limited to, a welcome page, a borrower's page, a co-borrower page, an employment page, an income page, an assets and liabilities page, a loan page, a declarations page, a people tab page to collect and list people involved in a loan process and closing process along with their contact information, and a loan application release form; and
configuring the cloud-based mortgage software service to generate a customized workflow process for each individual borrower utilizing this software service based on the information being solicited out of the fields and forms of the cloud-based mortgage software service, which the extracted information then causes the triggering of conditions associated with the borrower documentation needed for the underwriter as well as the mortgage software service to present any additional on-line forms to be filled out by the borrower based on the trigger conditions.

13. The method of claim 12, further comprising:
configuring the cloud-based mortgage software service to have one or more application programming interfaces with two or more of the direct lending institutions and configuring the cloud-based mortgage software service to establish a secure communication link between each direct lending institutions and the provider site;
configuring the mortgage software service to establish the secure communication link by creating a tunnel at the socket layer and encrypting any data while in transit between each direct lending institutions and the provider site as well as to satisfy any additional authentication mechanisms required by the direct lending institution, including but not limited to IP address white listing and token based authentication, configuring the cloud-based mortgage software service to have a calendar that tracks activity dates associated with the loan approval and loan and real estate closing process and shares the tracked activity on the calendar when actions occur by a lender regarding the loan, which allows a borrower viewing the calendar to instantly let the borrower know what is a status of the loan approval and what to expect in the closing process as well as to convey when the next steps in the loan and real estate closing process are expected to occur;
configuring the mortgage software service to allow loan officers to send notifications to and requests of the borrower through the mortgage software service to the borrower to close an approved loan, where the borrower can provide any requested information and documentation via pages presented by the software service; and
configuring the mortgage software service to have a first routine coded to detect when the person makes an activity occur regarding the loan approval or closing process, where the activity includes i) the borrower providing a document or other information through the mortgage software service and ii) when the loan officer makes an entry on the calendar, then configuring the first routine to provide at least the borrower and the loan officer with an electronic notification to their phone or e-mail account information extracted from the people tab page when this activity occurs regarding the loan approval or closing process.

14. The method of claim 11, further comprising:
configuring the cloud-based mortgage software service to cooperate with a second database of the one or more databases, where the database indexes and contains one or more trigger conditions that trigger the need for the documentation needed by the mortgage guidelines of government-sponsored lending institutions and the overlays of the direct lending corporations, where the first database contains and indexes i) documentation needed under every possible situation for a loan approval from the government-sponsored lending institutions underneath its mortgage guidelines as well as ii) all of the potential documentation needed based on the investor overlays from the two or more the direct lending institutions;
configuring an application programming interface in the mortgage software service to allow each direct lending institution to create multiple instances of investor overlays to be applied regarding that direct lending institution based on information including but not limited to i) a type of loan being requested, ii) an amount of the loan being requested, iii) an amount of assets or income of the borrower requesting the loan, iv) employment history, v) credit history, vi) asset history, vii) and any other borrower liabilities including alimony and child support, and vii) any combination of these factors; and
configuring the cloud-based mortgage software service to generate and post a list of documentation that will be needed from this particular borrower for the loan based on their extracted information, after a first routine of the software service reconciles the extracted information against the conditions that triggered the borrower documentation needed.

15. The method of claim 14, further comprising:
configuring the cloud-based mortgage software service so that the trigger conditions are associated with each different document type needed for the loan application process in the databases, and the first routine matches information supplied from the fields and forms to a need to verify the extracted information with a type of documentation;
configuring the software service to present a documents folder with the list of documents needed as well the list with explanations of what types of documents satisfy this requirement;
configuring the mortgage software service to present an icon to upload those documents at this time or sometime in the future;
configuring the software service to submit the complete loan application and accompanying documentation when the entire application and all accompanying documents can be submitted, which should increase conversion rates of applications into approved loans because the submitted complete loan application will have both the required information solicited as well as all of the needed borrower documentation to approve the loan; and
configuring the cloud-based mortgage software service to have application programming interfaces with direct lending corporations and establishes a secure communication channel to a server site for at least one of the different lending institutions in order to send the borrower's loan application with all required forms and accompanying documentation at a start of loan process to that direct lending corporation.

16. The method of claim 11, further comprising:
configuring the software service to have a documents folder with the list of borrower documents currently uploaded and borrower documents still needed, and that page of the software service has both i) an upload icon to upload a file as well as ii) a linked accounts icon to allow the borrower to securely connect another online account of the borrower in order to allow a borrower to authenticate themselves to their online account quickly originate a request to the online account to share the borrower's account information with the provider site to obtain information and documents necessary to process the borrower's loan that may satisfy one or more requests for documentation i) in lieu of, or ii) supplemental to documents uploaded directly by the borrower; and
configuring the software service to have a calendar that tracks activity dates associated with the loan approval and closing process and shares the tracked activity on the calendar when actions occur by a lender regarding the loan to let the borrower know what is a status of the loan approval and what to expect in the closing process.

17. The method of claim 11, further comprising:
configuring the cloud-based mortgage software service to have one or more application programming interfaces with the one or more direct lending institutions to load the documentation and loan application forms into a database of that direct lending institution;
configuring each application programming interface of the software service to export the loan application information as generic data, including a Fannie Mae formatted file, and send accompanying documentation as an electronic document in standard readable format across a secure communication channel to the database of that direct lending institution;
configuring the loan application information and accompanying documentation of the borrower to be stored in an encrypted form while stored in the one or more databases of the provider site; and
configuring the mortgage software service to present a graphic user interface to the one or more direct lending institutions as well as other on-line institutions to allow these institutions to customize in what fields and formats the application programming interface of the software service exports information from the software service into a system used by that institution so that merely minor changes, if any, are required for the system in that institution to use the exported information.

18. The method of claim 11, further comprising:
configuring the cloud-based mortgage software service to have an interface coded to interact and cooperate with a third party interface so that a borrower may authenticate themselves with one or more online information institutions so that a borrower's financial information and documentation stored in that online information institution can be requested by the software service and in response to the request, then the online information institution can electronically send the documentation on a borrower's assets over the network via a secure tunnel from the online information institution of the borrower to the provider site; and
configuring an application programming interface of the software service to export the loan application information and accompanying documentation by understanding and mapping the semantics of direct lender's system and exporting the loan application information and accompanying documentation with the names and nomenclature used by the direct lender's system.

19. The method of claim 11, further comprising:
configuring the cloud-based mortgage software service to present a document folder with the list of needed borrower documents that will be needed by the underwriter, then the borrower can activate an icon next to each of the presented document requests customized for that borrower, and the borrower can activate the upload icon in order to upload the corresponding borrower's document securely to the provider site via a secure tunnel over the network between the client device and the provider site, where an identity of both a sending device and a receiving device are verified in a secure exchange of information through the secure tunnel; and
configuring the software service to also generate an electronic notification, including e-mail, text message, or other notification to a borrower's e-mail account or phone number, where the electronic notification regards missing documents still needed by the underwriter.

20. The method of claim 11, further comprising:
configuring the cloud-based mortgage software service to have one or more application programming interfaces;
configuring the cloud-based mortgage software service to establish a secure communication link with two or more on-line financial institutions;
configuring the cloud-based mortgage software service to have one or more application programming interfaces with two or more direct lender's loan origination systems;
configuring the cloud-based mortgage software service to establish a secure communication link with the direct lender's loan origination systems;
configuring the cloud-based mortgage software service to have one or more application programming interfaces with one or more asset verification sites with a secure communication link between the asset verification site and the provider site in order to allow a borrower's assets entered into the field and forms of the software service to be verified by the asset verification site; and
configuring the cloud-based mortgage software service to then receive the verification of the borrower's assets from the asset verification site, which they the software service exports the verification of a borrower's assets to the direct lender's loan origination system, wherein the cloud based mortgage software service is a middle support service interconnecting the on-line financial institutions, the direct lender's loan origination systems, and the asset verification sites.
